(19) United States
(12) Patent Application Publication
(10) Pub. No.: US 2006/0271399 A1
(43) Pub. Date: Nov. 30, 2006

(54) System and method that provide office management functionalities

(76) Inventors: James F. Robson SR., Tolland, CT (US); Jason J. Epperson, New Haven, CT (US); Joseph F. Acker III, Killingworth, CT (US); Michael J. Brooks, Hamden, CT (US); Michael Swyers, Montreal (CA); Prakash D. Parikh, Hamden, CT (US)

Correspondence Address: McCARTER & ENGLISH, LLP;Attn.: Anita Lomartra, CityPlace I, 185 Asylum Street, Hartford, CT, 06103, US

(21) Appl. No.: 11/141,489

(22) Filed: May 31, 2005

(51) Int. Cl. G06Q 10/00; G05B 19/418

(52) U.S. Cl. 705/2; 705/8

(57) ABSTRACT

A computer-based system and method for supporting office/practice management offers enhanced patient/client/customer registration functionalities that facilitate efficient and reliable intake and maintenance of patient/client/customer relationships. The system/method includes a patient preference functionality that facilitates appointment scheduling and a “patient flag” functionality that supports extensibility (e.g., linking to an associated document, record or other electronically accessible resource). The system also provides enhanced appointment scheduling functionalities that facilitate efficient and reliable identification of service provider availability (together with any required supporting equipment and/or personnel), including an “appointment candidate generator”, a “floating” or “overlaid” provider pane, an “appointment capsule” that facilitates appointment scheduling/rescheduling, a “time block freeze” that allows multiple users to interact with records in the central database without creating inconsistencies and/or anomalies, a “clear day” functionality that facilitates global changes to a service provider's calendar for a given day (or series of days), and a design that supports “drag-and-drop” of files/data across multiple data files/records. The disclosed system/method also supports billing functionalities that facilitate efficient and reliable generation of billing records (e.g., claims and/or statements) and reconciliation of payments received with respect to such billing records.

### BACKGROUND

1. Technical Field

The present disclosure is directed to systems and methods for facilitating data entry, data management, and data access and use. More particularly, the present disclosure is directed to computer-based systems that facilitate one or more functions that are generally associated with operations of a professional office, e.g., scheduling, billing and/or the creation, modification and/or control of appointments.

2. Background Art

With the widespread adoption of desk-top computing and computer networking, e.g., through the creation of intranets, extranets and the Internet, opportunities for enhancing the efficiencies of office-related operations have become apparent. Software applications have been developed to support a variety of office-related functions, including scheduling, billing and the creation, modification and/or control of appointments. Some software applications are designed to include functions that support the activities of individuals involving in a wide variety of activities/industries, e.g., Microsoft Outlook, whereas other applications have been developed with particular applicability to one or more specific activities/industries. Thus, beyond a host of generic software applications, numerous niche software products and applications have been developed to support specific office settings.

Among the niche applications are software products/applications that are designed to support the operations of professional offices, e.g., office management and/or practice management applications. Office management and practice management products/applications are frequently designed to support the operations of health care professionals, e.g., physicians, surgeons, cardiologists, dentists and the like, although additional practice and/or industry fields also benefit from office and/or practice management software/applications, e.g., law offices, and a variety of service providers (e.g., repair shops, consultants and the like). In short, the market for effective, efficient and reliable office and/or practice management software/applications is large and diverse.

Existing office and/or practice management software/applications suffer from numerous shortcomings and/or limitations. For example, difficulties can arise when multiple users seek to simultaneously access/utilize a single file or record with existing systems, e.g., over a network. In such circumstances, a first user may not be aware that a second user is simultaneously changing/updating information associated with such file/record, and inconsistencies and/or conflicts may arise. In addition, existing office and/or practice management systems suffer from limitations with respect to scheduling functionality, making it difficult for users to efficiently and reliably identify and/or select potential scheduling options.

Thus, a need remains for enhanced office and/or practice management applications that address the shortcomings described above. These and other needs and limitations are overcome by the disclosed office management systems and applications.

### SUMMARY OF THE DISCLOSURE

Advantageous systems and methods for facilitating office and/or practice management applications are provided herein. The disclosed systems and methods permit system users to efficiently, effectively and reliably manage office and/or practice operations, including registration, scheduling and/or billing functionalities. According to exemplary embodiments of the present disclosure, the systems and methods include and/or are implemented through one or more software application(s) that are adapted to operate on one or more processing units, e.g., one or more servers, processors or the like. The software application(s) associated with the disclosed systems/methods are generally adapted to operate over computer networks as are known in the art, e.g., intranets, extranets and/or the Internet. Indeed, exemplary embodiments of the present disclosure are adapted to support operations in multiple locations, e.g., a multi-office professional practice.

Implementation of the disclosed systems and methods generally involves shared access to a central database that contains data relevant to the office and/or practice management of a user. The disclosed software is adapted to access the central database so as to provide the advantageous registration, scheduling and/or billing functionalities described herein. The software may function within an application service provider (ASP) environment, or may be installed on individual servers/processors at individual locations. In a further exemplary implementation of the present disclosure, the software may reside on a central server at each location office/practice location, with individual users at such office/practice location accessing such software over a network established at such office/practice location.

According to exemplary embodiments of the present disclosure, the disclosed software is particularly adapted to operate within and leverage functionalities associated with Macromedia Flash software (Macromedia, Inc., San Francisco, Calif.), e.g., Macromedia Flash MX (version 6). The underlying design, operation and functionalities associated with Macromedia Flash applications are known in the art and are described in documentation that is available from Macromedia, Inc. (www.macromedia.com). The underlying design, operation and functionalities associated with the commercially available Macromedia Flash products, as described in product literature associated with such product and available from Macromedia, Inc., are incorporated herein by reference. Exemplary embodiments of the present disclosure also utilize and/or leverage functionalities associated with the ASBroadcaster utility embodied in Macromedia Flash, e.g., through broadcastMessage commands that enable an object to send a message that will be captured by any objects listening to it.

The disclosed systems and methods provide numerous advantages as compared to prior art office and/or practice management systems, including:
Enhanced patient/client/customer registration functionalities that facilitate efficient and reliable intake and maintenance of patient/client/customer relationships, including a patient preference functionality that facilitates future appointment scheduling, and a “patient flag” functionality that allows and/or supports extensibility (e.g., linking to an associated document, record or other electronically accessible resource).
Enhanced appointment scheduling functionalities that facilitate efficient and reliable identification of service provider availability (together with any required supporting equipment and/or personnel), including an “appointment candidate generator” functionality, a “floating” or “overlaid” provider pane functionality, an “appointment capsule” functionality that facilitates appointment scheduling/rescheduling, a “time block freeze” functionality that allows multiple users to interact with records in the central database without creating inconsistencies and/or anomalies, a “clear day” functionality that facilitates global changes to a service provider's calendar for a given day (or series of days), and a design that supports “drag-and-drop” of files/data across multiple data files/records (e.g., drag-and-drop of .swf files associated with Macromedia Flash).
Enhanced billing functionalities that facilitate efficient and reliable generation of billing records (e.g., claims and/or statements) and reconciliation of payments received with respect to such billing records, including functionalities that ensure/verify pre-validation of payer data, an advantageous billing claim identification methodology, a “countdown” functionality adapted to track and update the status of an individual's visits relative to a predetermined number of authorized visits, and location-specific CPT/Medicare fee schedules that are automatically matched to a patient's billing records.

The disclosed system and method offers an integrated, user-friendly approach to office and/or practice management that addresses the varied needs of administrators, support staff and professional service providers. Exemplary embodiments of the present disclosure support users to establish varying levels of security with respect to various functionalities and/or data access/manipulation. Moreover, the disclosed system/method is designed to comply with privacy concerns/issues associated with patient/client/customer records, e.g., HIPAA.

These and other features and functionalities will be apparent from the detailed description which follows, particularly when reviewed in conjunction with the figures appended hereto. Although the systems and methods of the present disclosure are described with reference to exemplary embodiments herein, it is to be understood that the present disclosure is not limited by such exemplary embodiments, but rather extends to and embraces modifications, variations and/or enhancements which may be made thereto, as will be readily apparent to persons skilled in the art.

### BRIEF DESCRIPTION OF THE FIGURES

To assist those of ordinary skill in the art in making and using the disclosed systems and methods for providing office and/or practice management functionalities, reference is made to the accompanying figures, wherein:

FIG. 1 is a block diagram of an exemplary system according to the present disclosure;

FIG. 2 is an exemplary log-in screen according to an illustrative implementation of the present disclosure;

FIG. 3 is an initial navigation screen according to an exemplary implementation of the present disclosure;

FIG. 4 is a patient information and demographics screen according to an exemplary implementation;

FIG. 5 is a further patient information and demographics screen according to an exemplary implementation;

FIG. 6 is an additional patient information and demographics screen according to an exemplary implementation;

FIG. 7 is a conditions-related screen according to an exemplary implementation;

FIG. 8 is a guarantor and payers screen according to an exemplary implementation;

FIG. 9 is a further guarantor and payers screen according to an exemplary implementation;

FIG. 10 is a liability claims, incoming referrals and pre-certifications screen according to an exemplary implementation;

FIG. 11 is a further liability claims, incoming referrals and pre-certifications screen according to an exemplary implementation;

FIG. 12 is a logs screen related to appointments, lab referrals and prescriptions according to an exemplary implementation;

FIG. 13 is a further logs screen according to an exemplary implementation;

FIG. 14 is an appointment book screen according to an exemplary implementation of the present disclosure;

FIG. 15 is a further appointment book screen according to an exemplary implementation;

FIGS. 16-30 are additional appointment book screens according to an exemplary implementation of the present disclosure;

FIG. 31 is billing screen according to an exemplary implementation of the present disclosure; and

FIGS. 32-44 are additional billing screens according to an exemplary implementation of the present disclosure.

### DETAILED DESCRIPTION OF EXEMPLARY EMBODIMENT(S)

The present application provides advantageous systems and methods for providing office and/or practice management functionalities. As described herein, the disclosed systems and methods permit system users to efficiently, effectively and reliably manage office and/or practice operations, including registration, scheduling and/or billing functionalities. The disclosed systems and methods are implemented through software that is adapted to operate on one or more processing units, e.g., one or more servers, processors or the like, that generally communicate over one or more computer networks, e.g., intranets, extranets and/or the Internet. Exemplary embodiments of the present disclosure are adapted to support operations in multiple locations, e.g., a multi-office professional practice.

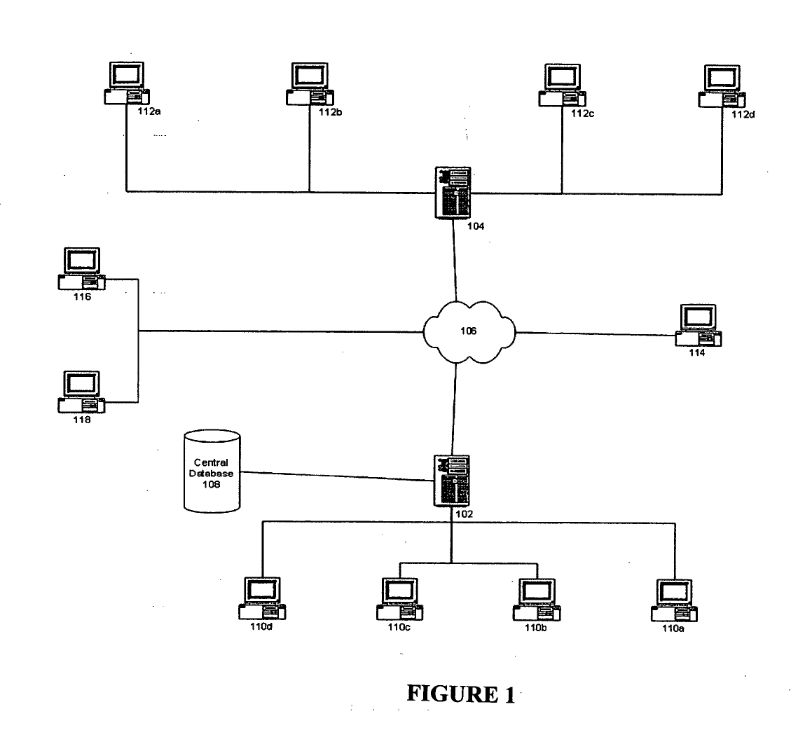

With reference to FIG. 1, a block diagram of an exemplary system 100 for providing advantageous office and/or practice management according to the present disclosure. System 100 includes a first server 102 and second server 104 that are adapted to communicate across a network 106, e.g., an intranet, an extranet and/or the Internet. First server 102 communicates with central computer storage 108 which includes one or more databases associated with the office and/or practice management functionalities disclosed herein. Of note, second server 104 also generally communicates with computer storage that is particularly associated therewith (not pictured); however, according to exemplary embodiments of the present disclosure, a single computer storage location (e.g., computer storage 108) is typically utilized to maintain the various databases associated with implementation of the disclosed systems and methods.

With further reference to FIG. 1, a plurality of system users are schematically depicted. System users 110a, 110b, 110c and 110d represent processing units that are in communication with first server 102 and, in turn, network 106. According to the block diagram of FIG. 1, system users 110a-110d are physically located at a single location, e.g., an office associated with a multi-office operation or practice, and first server 102 and central database 108 are also located at such physical location. However, according to the present disclosure, it is contemplated that the central database (and associated server or servers) may be located at a remote location accessible over the Internet, e.g., at the facility of an application service provider (ASP). It is noted that an ASP implementation of the present disclosure may offer system user advantages, e.g., reduced capital expenditure and consistent/cost effective availability of technical support services.

System users 110a-110d may communicate with first server 102 through hard wire communication technology, e.g., copper and/or fiber structured cabling systems, or through wireless communication technology (or a combination thereof). Although central database 108 is schematically depicted as being at the same physical location as first server 102, the present disclosure is not limited to implementations wherein a central database 108 and first server 102 are co-located. Rather, network technologies may be utilized so as to distribute the physical location of individual hardware components of the disclosed system/method in any manner desired by the system user.

As described in greater detail below, system users 110a-110d access software associated with the disclosed office and/or management functionalities of the present disclosure. The software may reside/operate on a system user's individual processing unit, on first server 102, on second server 104, or a combination thereof. According to exemplary embodiments of the present disclosure, the software is designed to leverage the features and functionalities of Macromedia Flash software. In implementing applications utilizing Flash technology, Flash player software resides/operates on the system user's individual processing unit, and an associated Flash communication software, e.g., Flash Communication Server MX, resides/operates on first server 102, second server 104, or a combination thereof. The office and/or practice management systems and methods of the present disclosure may be implemented with a variety of hardware and software systems which permit and/or support conventional computer operations, e.g., data input, data storage, data back-up, network communications, and the like. The design and operation of an appropriate computer network for implementation of the disclosed office and/or practice management systems and methods are well within the skill of persons of ordinary skill in the art.

As shown in the block diagram of FIG. 1, exemplary system 100 also includes system users 112a, 112b, 112c, 112d in communication with second server 104 (and ultimately network 106). As depicted in FIG. 1, system users 112a-112d are physically located at a distinct location relative to system users 110a-110d. Thus, for example, a regional medical practice may have multiple office locations, e.g., in adjacent towns. Indeed, a medical practitioner (e.g., a pediatrician) associated with such regional medical practice may have office hours at each of the office locations, thereby requiring the support/administrative staff to be able to effectively and reliably-schedule appointments for such practitioner at the various locations, as appropriate. The block diagram of FIG. 1 further depicts a system user 114 that is located at a third distinct location and that communicates with first server 102 and/or second server 104 over network 106. System user 114 could be representative of a third office location or an individual who is accessing the disclosed system 100 from a remote location, e.g., his/her home, a laptop or PDA device (having requisite user interface capabilities/functionalities) while traveling, or the like. As is readily apparent from the schematic depiction of FIG. 1, system 100 may be scaled to fit the needs of a particular office and/or practice application, extending to the number of office locations and/or system users that are associated with each particular office/practice.

As also shown in FIG. 1, one or more third parties may be in communication with the disclosed system 100, e.g., insurance provider 116a and/or third party payer 118. Thus, for example, invoicing for services provided by the disclosed office/practice may be electronically transmitted to one or more insurance providers 116 and one or more third party payers 118 (e.g., Medicare, Medicaid, etc.) to facilitate payment processing activities. In such circumstance, a system user (e.g., system user 112a) may transmit claims and/or statements generated by the disclosed system/method over network 106 to an appropriate recipient for processing and/or payment.

Although the present disclosure has been described with reference to an exemplary system architecture as depicted in FIG. 1, it is to be understood that the systems and methods of the present disclosure are not limited to the exemplary implementation that is schematically therein. Rather, alternative system architectures may be employed without departing from the spirit or scope of the present disclosure. Indeed, the schematic depiction of system 100 in the block diagram of FIG. 1 is merely illustrative of an exemplary implementation of the disclosed systems and methods, and is not limiting thereof.

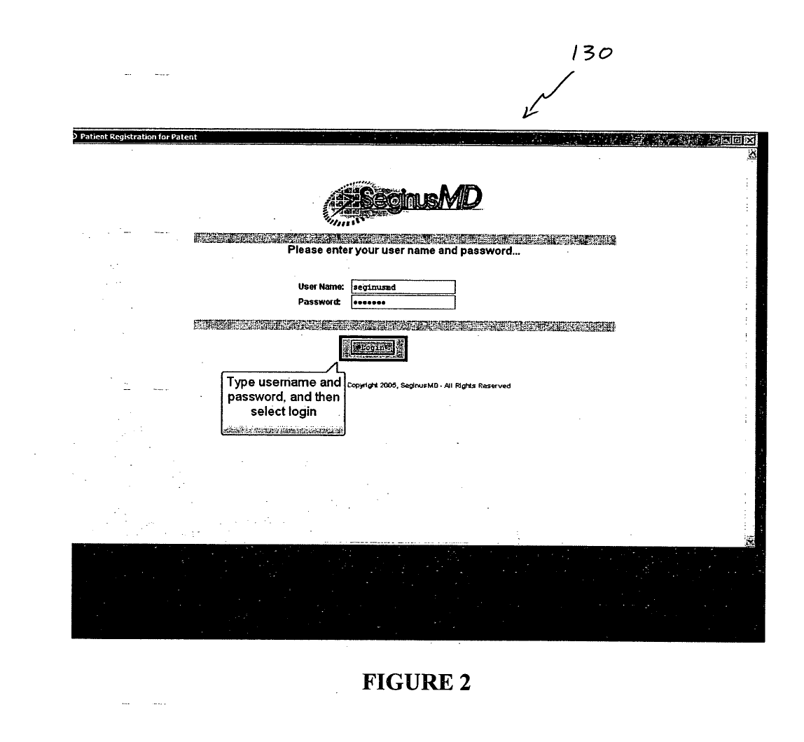

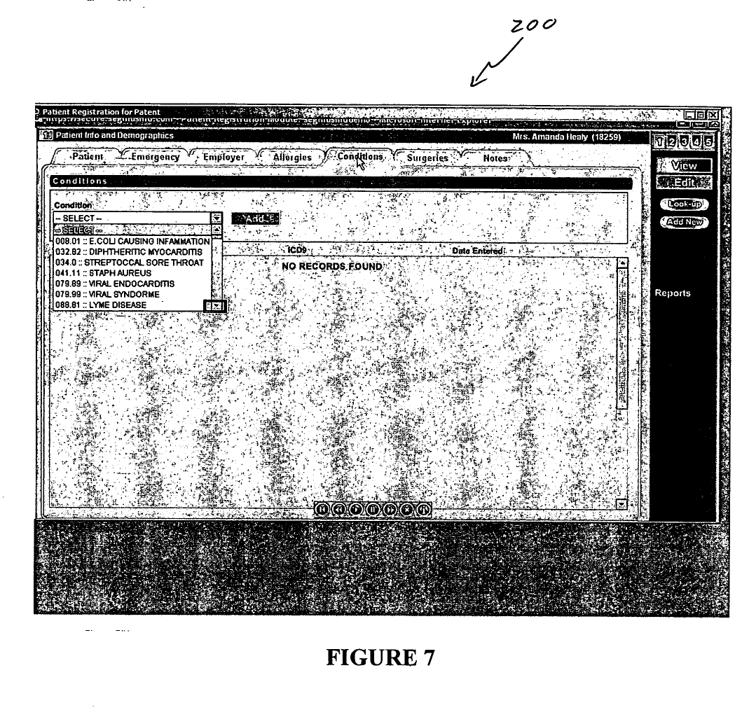

Turning to the screen shots of FIGS. 2-44, exemplary implementations of advantageous features and functionalities associated with the disclosed office and/or practice management systems/methods of the present disclosure will now be described. Although the present disclosure expressly encompasses systems and methods for providing and/or supporting advantageous office and/or practice management, the discussion which follows will be directed to an exemplary system thereof. It should be understood that the detailed description which follows also applies to exemplary implementations of the disclosed methods for providing office and/or practice management.

As shown in FIG. 2, the disclosed system generally includes a conventional sign-in screen 130. Thus, a system user operating at his/her computer terminal enters his/her name and password. The password may be used to in associating individual users with varying levels of security clearance. Thus, for example, certain users may have access to confidential information associated with patients/customers/clients, while other system users may not have such clearance. Once the name and password are verified by the system, the system user is generally provided with an initial screen from which navigation through the system functionalities is permitted.

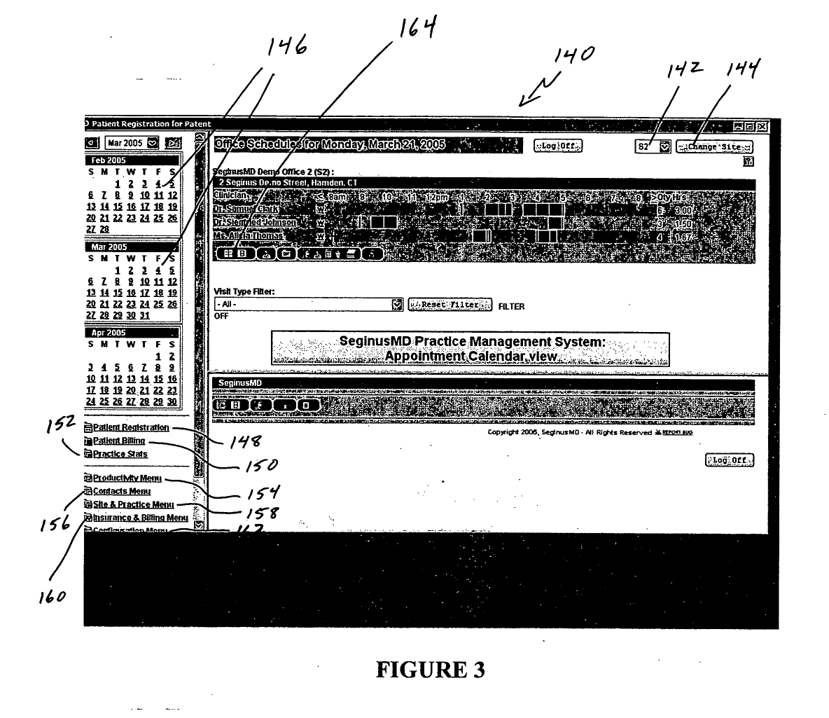

With reference to FIG. 3, an exemplary Appointment Calendar/Gantt screen view 140 is depicted. The Gantt screen 140 offers overview information concerning scheduling for a single office (“SeginusMD Demo Office 2 (S2)”) within an illustrative multi-office medical/physician practice. Of note, overview information for alternative office locations may be accessed through drop-down menu 142 or the “Change Site” link 144 toward the top/right of screen 140. The overview information provided on Gantt screen 140 includes scheduling information with respect to three clinicians (Dr. Clark, Dr. Johnson and Ms. Thomas). Each of the clinician names on screen 140 provides a link to an appointment schedule screen for that day and for that clinician.

Along the left side of screen 140, calendar links 146 are provided which allow a system user to access and view scheduling information (both retrospective and prospective) for a date of particular interest. Below calendar links 146 are a series of additional links: Patient Registration link 148, Patient Billing link 150, Practice Stats link 152, Productivity Menu link 154, Contacts Menu link 156, Site & Practice Menu link 158, Insurance and Billing Menu link 160, and Configuration Menu link 162. For purposes of the present disclosure, advantageous features and functionalities associated with patient registration according to the present disclosure will be described. However, it is to be understood that the features and functionalities described herein may be translated to different office/practice settings, e.g., dentists, optometrists, mechanics, law offices, etc. Thus, the exemplary features and functionalities described with reference to a medical/physician practice are not limiting of the scope of the present disclosure, but merely illustrative thereof.

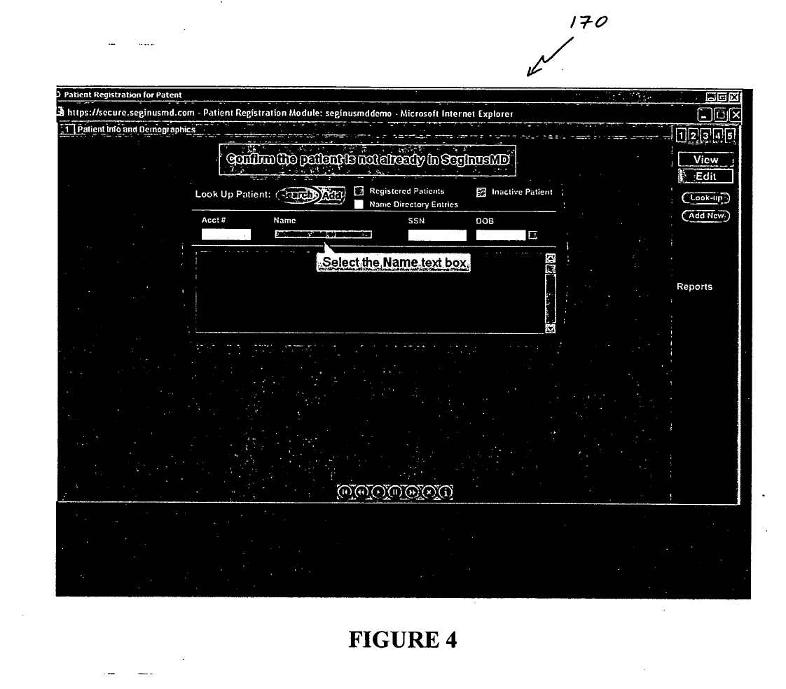

With reference to FIG. 4, a look-up screen 170 is provided for assessing whether the patient-of-interest has already been entered into the database associated with the office/practice operation. The search criteria available according to look-up screen 170 include name, account number, social security number and date of birth, although alternative and/or additional search terms may be employed, as will be apparent to persons skilled in the art.

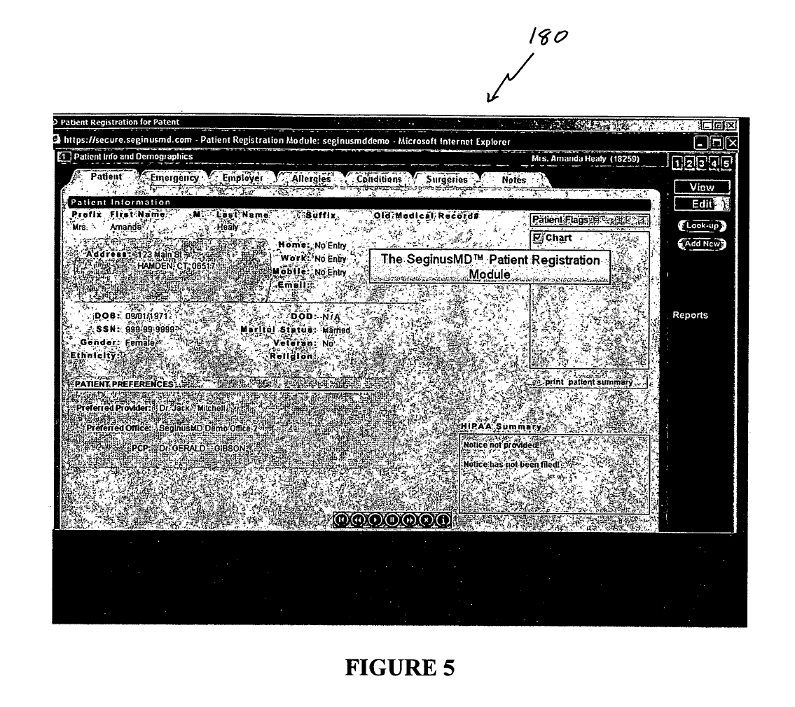

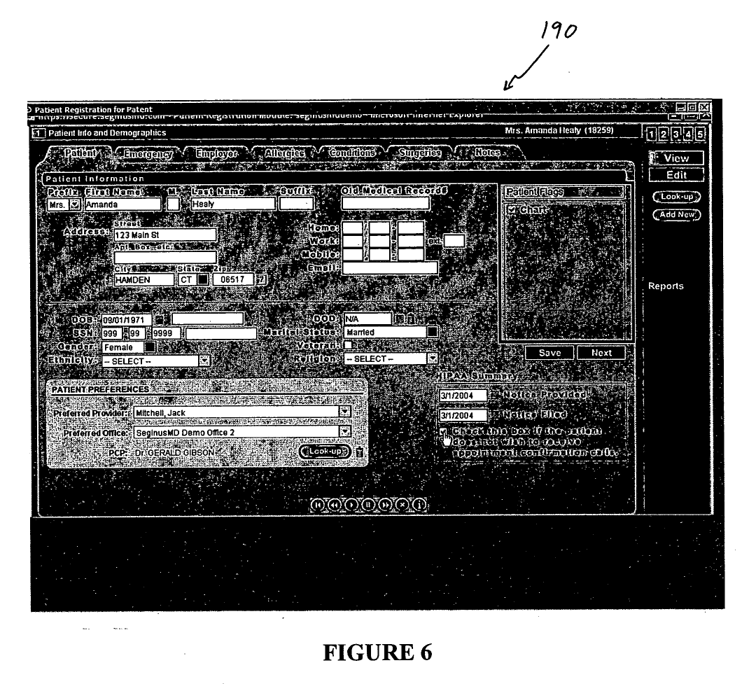

An exemplary patient screen 180 (“Mrs. Amanda Healy”) is provided in FIG. 5. Navigation links along the right side of screen 180 facilitate various patient registration-related activities, including editing of the record for Mrs. Healy. An exemplary data input screen 190 is provided in FIG. 6. Among the input fields are:
Patient preferences (e.g., preferred provider/clinician, preferred office location)
HIPAA-related information (e.g., HIPAA notice-related information and patient's preference as to appointment confirmation calls)
Patient Flags (e.g., links to ancillary documents and/or electronic resources)

With further reference to data input screen 190, a series of data entry tabs are arrayed in a horizontal line toward the top of the screen. The tabs permit entry of data with respect to the patient, emergency contact information, employer, allergies, conditions, surgeries and notes with respect to the patient. In addition, a series of data input “levels” (levels 1-5) are linked in the upper right corner of screen 190 (above the “view” link). Each level corresponds to a different category of information related to patient registration. Screen 190 relates to “Patient Info and Demographics” and corresponds to level 1 for purposes of the exemplary embodiment illustrated herein.

According to exemplary embodiments of the present disclosure, search and/or look-up functions are provided with respect to various aspects of the data entry functions, e.g., employer, allergies, conditions, etc., so as to streamline the data entry process and avoid inconsistent and/or redundant data entry. The search/look-up functionalities advantageously generate a list of potential “matches” based on the search criteria input by the system user, and a correct/matching option is generally selected by “clicking” thereon. The disclosed system advantageously translates all relevant information from the selected item into the relevant field, e.g., the entire employer name, address, phone number, etc.

In addition to look-up/search functions, exemplary implementations of the present disclosure are pre-populated with relevant information for use by system users. For example, as shown in Conditions data input screen 200, a plurality of conditions with assigned ICD9 codes (International Classification of Diseases—9^{th} Revision) are provided in a drop-down menu for review/selection by system users. The pre-population of the disclosed system with relevant information may be undertaken by or on behalf of the system provider, by the system user, or a combination thereof. In addition, it is contemplated that periodic data updates will provided to system users, e.g., updated conditions/ICD codes, so as to ensure that system users are operating with up-to-date information.

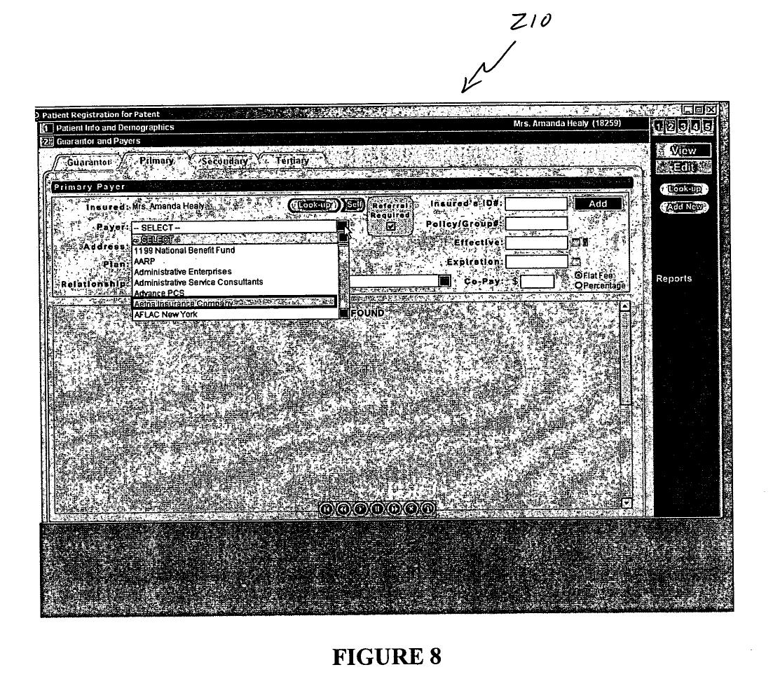

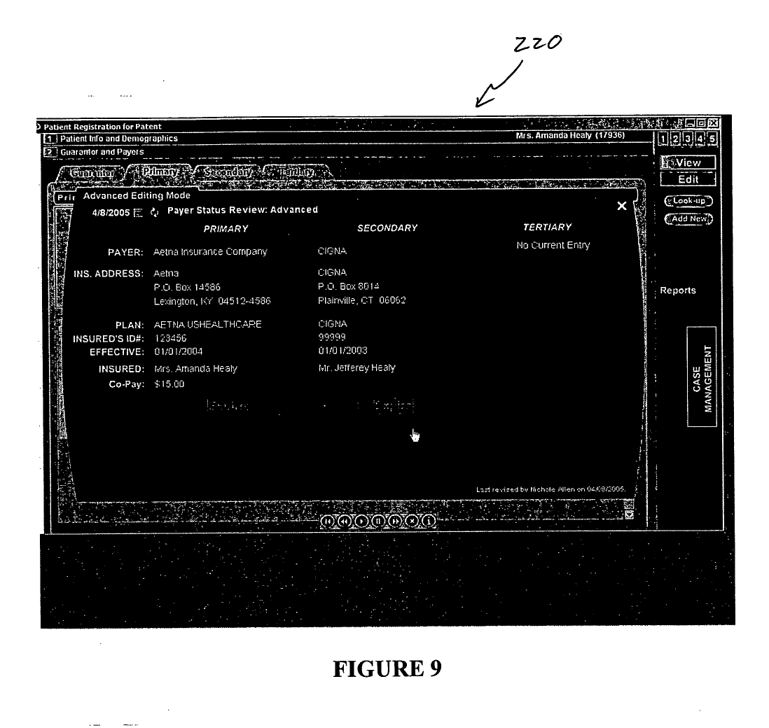

Turning to FIG. 8, a data input screen 210 associated with level 2 (Guarantor and Payers) is depicted. At this level, information concerning a patient's insurance coverage and related policy specifics (e.g., referral necessity) are input to the system. As shown in the advanced editing screen 220 of FIG. 9, exemplary embodiments of the present disclosure facilitate efficient repositioning of insurance plans as between primary, secondary and tertiary coverage. Thus, for example, primary and secondary insurance payers may be swapped using the navigation arrows positioned below the respective columns. The ability to redefine and/or modify the status of individual insurance payers without re-entry of underlying insurance data greatly expedites the data management process and minimizes potential data entry errors.

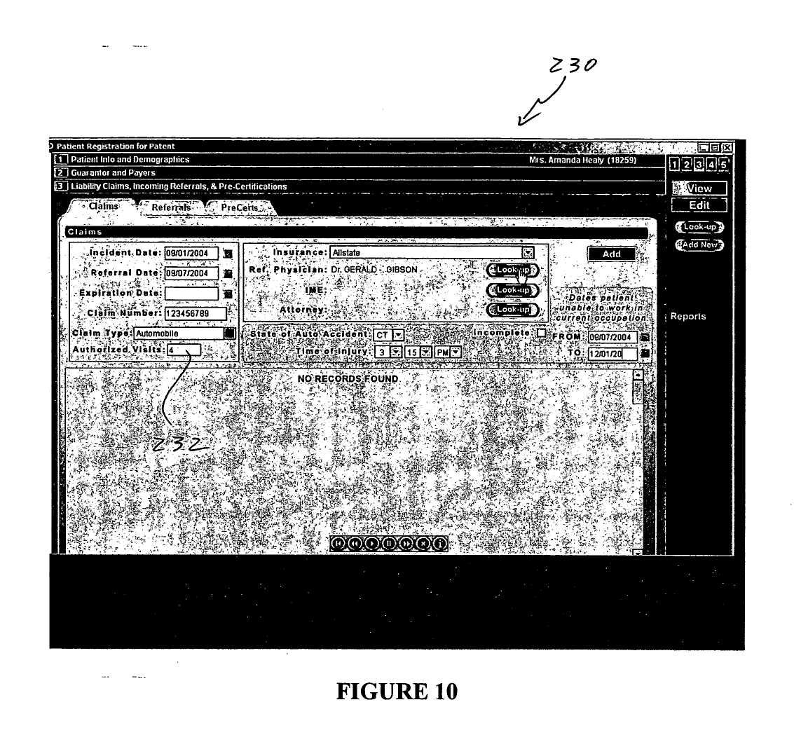

With reference to FIG. 10, data entry screen 230 associated with level 3 (Liability Claims, Incoming Referrals, & Pre-Certifications) is provided. As shown on the exemplary data input screen of FIG. 10, data entry fields for information relevant to a “claim” (e.g., automobile accident) are provided. Among the data fields to be completed is data field 232 for inputting the number of authorized visits associated with the claim. Of note, exemplary embodiments of the disclosed system provide advantageous functionalities associated with the number of authorized visits. For example, the disclosed system tracks the number of visits that have occurred with respect to a particular claim, and makes the number of visits remaining known to system users, e.g., by way of an advantageous “count-down” feature which is described in greater detail below.

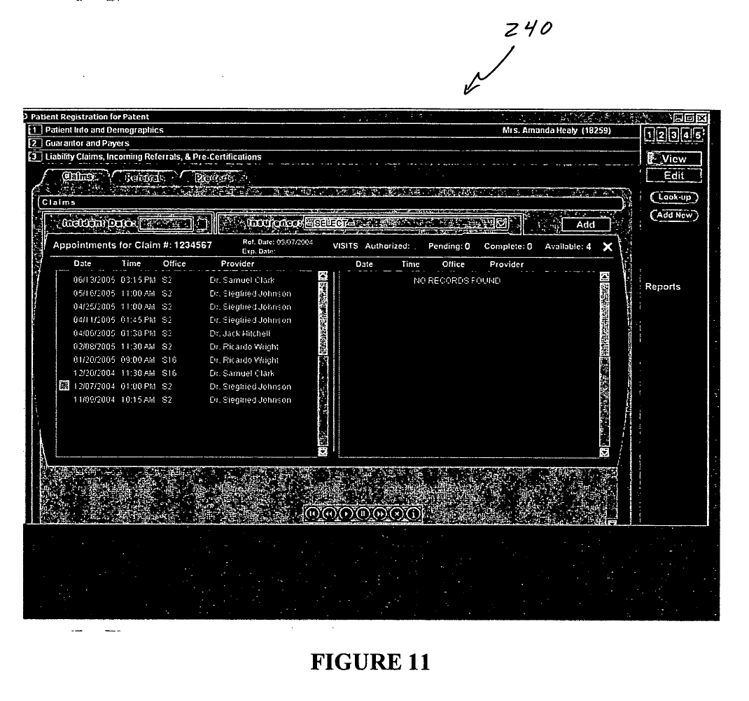

As shown in FIG. 11, exemplary embodiments of the present disclosure provide advantageous functionalities that permit individual physician visits to be associated with or matched to a specific claim. Thus, as shown in the claim-related appointments screen 240 of FIG. 11, the 4 authorized visits associated with claim #1234567 are noted, as is the fact that no visits associated with the noted claim are currently pending or complete. Accordingly, there are 4 visits available with respect to the noted claim. Using claim-related appointments screen 240, a system user is able to identify visits that are properly associated with the noted claim and, using drag-and-drop functionality, move the appropriate visits (if any) from the left column (which lists all patient visits that fall within the claim period) to the right column (which corresponds to visits that are directly related to the claim). To the extent a visit is moved from the left column to the right column, the disclosed system automatically recalculates the number of completed visits and the number of available visits, and displays the updated figures on screen 240. As will be readily apparent to persons skilled in the art, properly associating physician visits with a claim/authorization is frequently critical to receiving payment for such visit and associated service.

With further reference to FIG. 10, it is noted that adjacent the “claims” tab on screen 230 are tabs for “referrals” and “pre-certs” (i.e., pre-certifications). According to exemplary embodiments of the present disclosure, the disclosed system provides comparable functionality for inputting, tracking and associating visits with an authorized number of referral visits and pre-cert visits. Thus, for example, if a referral authorizes that a patient (e.g., Mrs. Healy) is authorized to have ten (10) visits to address a specific condition, the system provides a data entry field to capture the number of authorized visits associated with the referral, tracks the number of visits related to the referral, provides for drag-and-drop functionality to associate a visit with a particular referral, and displays updated information concerning the status of the patient's visits relative to the number of authorized visits.

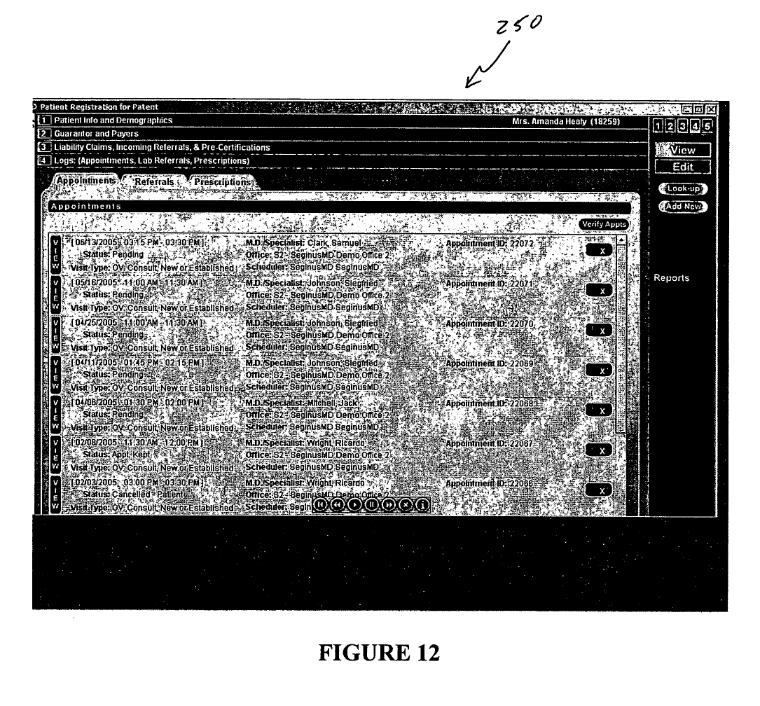

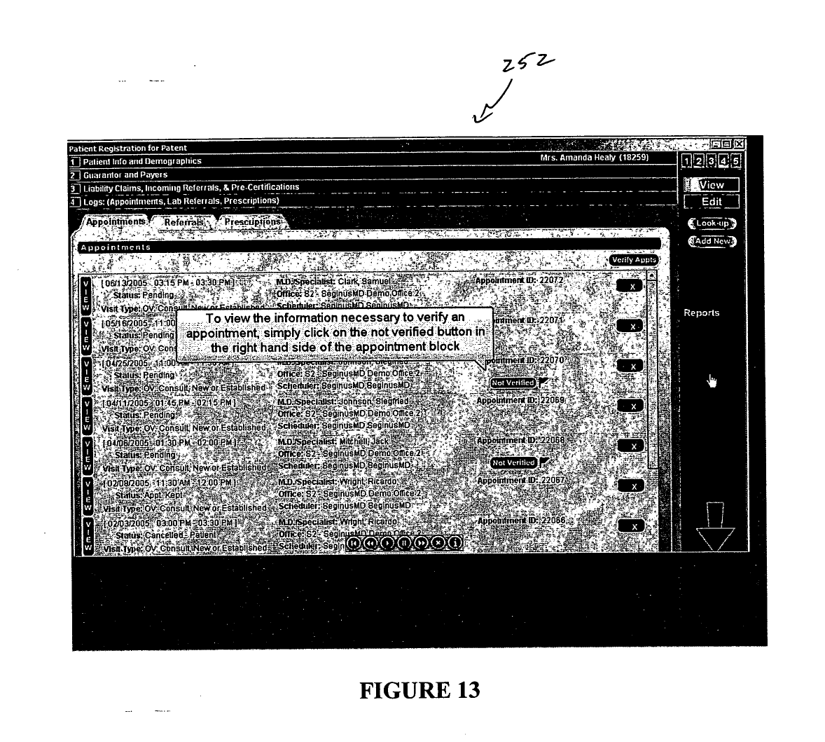

Turning to FIGS. 12 and 13, exemplary Appointments screens 250 and 252 associated with level 4 (Logs: Appointments, Lab Referrals, Prescriptions) data entry for patient registration according to the present disclosure are provided. The appointment screens 250, 252 list a series of appointments associated with the patient. A “view” link is provided to the left of each appointment entry, permitting a system user to view the appointment calendar for the day of any such appointment (including surrounding appointments, both for the assigned clinician and for other clinicians in the group). With particular reference to FIG. 13, two of the noted appointments include flags indicating that the appointments are “not verified”. These flags indicate that at least one piece of information concerning each of the noted appointments is missing. The system user can learn the nature of the missing information by clicking on the “not verified” link and viewing a screen summarizing the missing information, e.g., a .pdf document summarizing such information. Corrective action may be taken by the system user to determine and/or input the missing information. This feature/functionality of the disclosed system enhances the reliability of the appointment process and assists in the billing/collections process, since many times the missing information relates directly or indirectly to a billing/collections issue.

As described herein, the disclosed system provides advantageous patient registration features and functionalities. The disclosed system supports collection of relevant information related to the patient, e.g., demographics, insurance coverage and any restrictions on authorized visits. Moreover, the disclosed system provides advantageous functionalities that permit a patient's visits to be associated directly with a claim, referral and/or pre-certification, thereby facilitating billing and collections related thereto. Additionally, the disclosed system automatically tracks the number of patient visits that have been associated with a claim, referral and/or pre-certification, providing real-time information as to the status of such claim, referral and/or pre-certification, including the number of authorized visits that remain available. The appointment screen associated with a specific patient permits system users to view the totality of appointments/visits scheduled and/or made by a patient, with the ability to link to relevant appointment calendars, as desired. In short, the disclosed patient registration system offers many benefits and advantages relative to prior art patient registration systems, as will be readily apparent to persons skilled in the art.

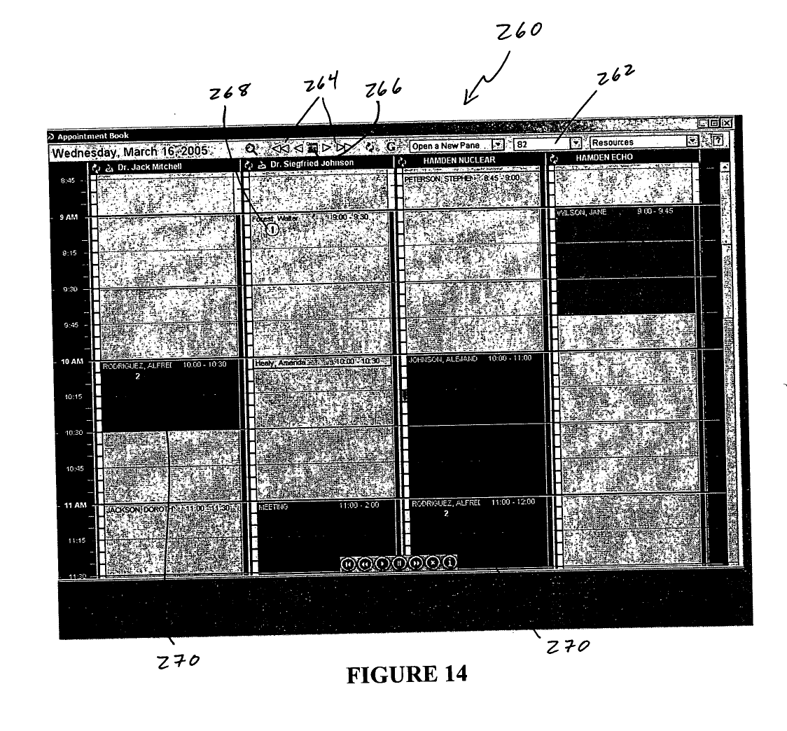

Turning to additional features and functionalities associated with the appointment-related aspects of the disclosed system, reference is again made to FIG. 3. As shown on exemplary screen 140, an appointment book icon 164 is provided thereon to facilitate access to advantageous appointment functionalities associated with the present disclosure. According to exemplary embodiments of the present disclosure, appointment book icon 164 links to an appointment book screen, e.g., exemplary appointment book screen 260 of FIG. 14. Screen 260 generally reflects appointment data for the then-current date. For purposes of FIG. 14, the then-current date is Wednesday, Mar. 16, 2005.

As shown in drop-down window 262, appointment book 260 relates to location “S2”, i.e., SeginusMD Office 2, from among the multi-offices under management by the disclosed office and/or practice management system. Navigation arrows 264 and calendar icon 266 permit system users to navigate to alternative dates within the electronic appointment book. Individual appointments are reflected in the vertical columns. The left-most column relates to appointments for “Dr. Jack Mitchell”, the next column relates to appointments for “Dr. Siegfried Johnson”, and the third column from the left relates to a specialized room/piece of equipment, the “Hamden Nuclear” facility. Thus, from a scheduling standpoint, the disclosed system simultaneously manages personnel and facility/equipment resources.

With particular reference to Dr. Johnson's appointment column, the appointment for “Walter Forest” at 9 a.m. includes a numeric icon 268, namely the numeral “1”. Icon 268 signifies the fact that the appointment for Mr. Forest will be his first appointment with the office/professional group, thereby alerting the professional staff and clinician to attend to those issues/details attendant to an initial visit. Of note, icon 268 is automatically generated by the disclosed system based on the patient registration information input with respect to Mr. Foster. Thus, the disclosed system automatically provides valuable information concerning new patients, communicating such information in a readily apparent, yet discrete, manner on the relevant appointment book entry.

With reference to the Dr. Mitchell's appointment column, the appointment for “Alfred Rodriguez” at 10 a.m. includes a numeric icon 270, namely the numeral “2”. Icon 270 signifies the fact that Mr. Rodriguez has two appointments scheduled for the same day, i.e., Mar. 16, 2005. The second appointment for Mr. Rodriguez appears on screen 260 in the “Hamden Nuclear” column at 11 a.m., which also bears an icon 270. While there are circumstances where multiple appointments for a single patient on a single day are necessary, it is also possible that a scheduling error has occurred. The disclosed system automatically monitors the scheduling of appointments for individual patients and incorporates an appropriate numeric icon, e.g., icon 270, with respect to a patient's appointments where he/she is scheduled on multiple times on a single day.

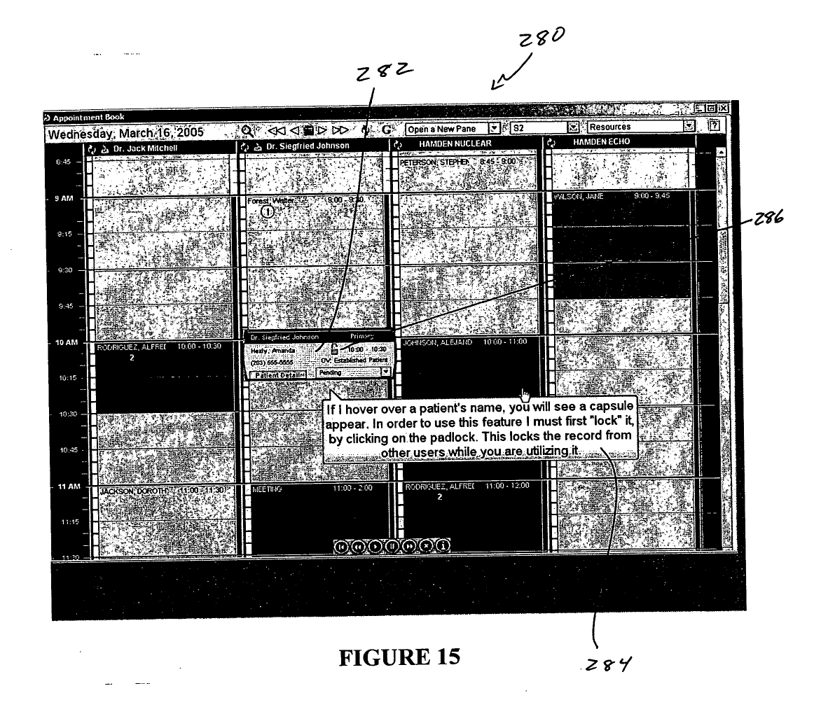

Turning to FIG. 15, appointment book screen 280 is a modified version of screen 260 in FIG. 14, in that an overlying capsule 282 has appeared above the 10 a.m. appointment for Amanda Healy with Dr. Siegfried Johnson. As noted in “balloon” 284, capsule 282 is caused to appear by hovering a system user's cursor over an appointment of interest, in this case, the 10 a.m. appointment for Ms. Healy. Capsule 282 includes basic information concerning the patient (name, phone number and condition), as well as additional advantageous features and functionalities associated with exemplary embodiments of the disclosed system. Of particular note, “padlock” icon 286 functions to “lock” the appointment record while a first system user is accessing and/or modifying the contents of such record. In order to use the functionalities available on capsule 282, the system requires that the “padlock” functionality be placed in the a locked condition. Padlock icon 286 is toggled between “locked” and “unlocked” conditions by clicking on the icon.

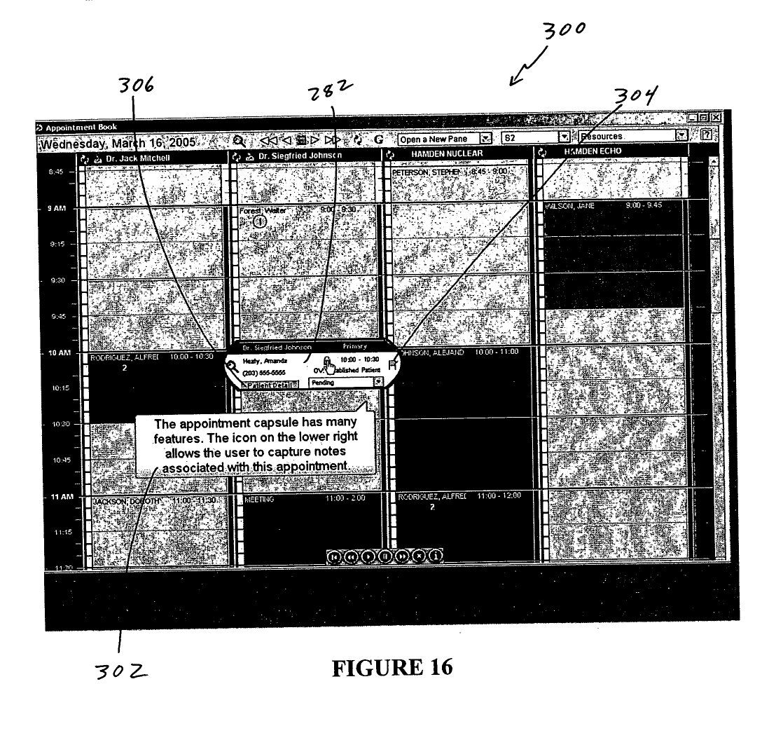

Turning to FIG. 16, screen view 300 shows that capsule 282 expands to include additional functionalities once the padlock is moved to the locked condition. In particular, as noted in balloon 302, a notes icon 304 appears at the right of capsule 282 when the padlock is in the locked condition. Notes icon 304 links to a data input screen that allows a system user to enter notes with respect to the patient visit. Such notes are automatically associated with and maintained with reference to the identified patient, i.e., Amanda Healy. According to exemplary embodiments of the present disclosure, patient detail link 306 allows a system user to view relevant patient information, e.g., by way of a summary screen that allows linkage to the underlying multi-level patient registration information repository described above.

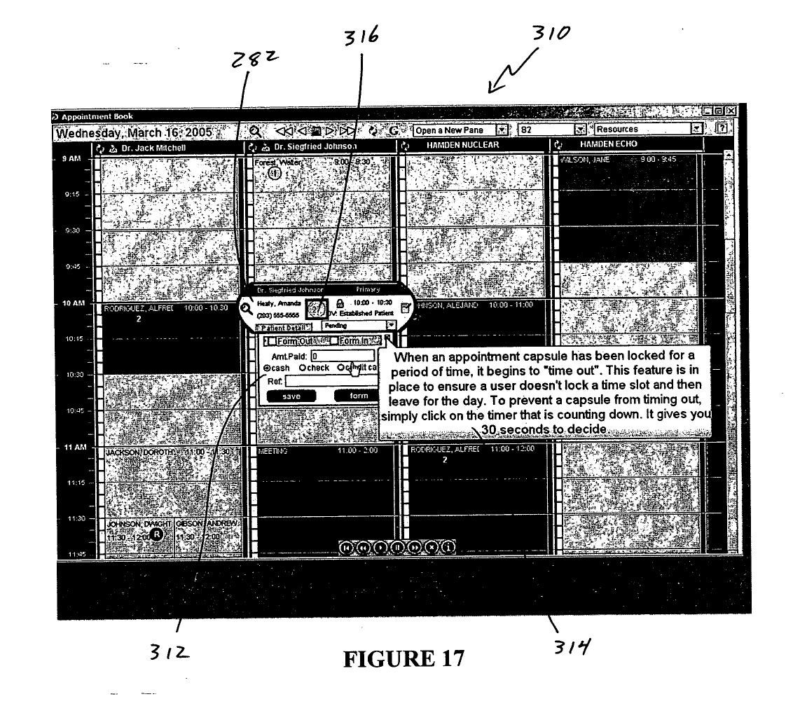

Turning now to FIG. 17, a further screen view 310 associated with an exemplary appointment book of the present disclosure is provided. As shown in FIG. 17, encounter box 312 overlays the appointment book. Encounter box 312 provides data entry fields for use by the system user in recording financial information related to the visit. Encounter box 312 offers a system user the ability to generate an encounter form for on-demand printing. This on-demand functionality is particularly advantageous for walk-ins and last minute appointments.

As noted in balloon 314, a time-out feature has been automatically activated by the disclosed system in connection with the extended period during which capsule 282 has been in a locked condition. As noted in balloon 314, the time-out feature is designed to ensure that a system user does not lock a time slot for an inordinate period. The time period giving rise to initiation of the time-out feature is generally pre-determined and, according to alternative implementations, may be modified by individual system users based on their office experiences and needs. In exemplary embodiments of the present disclosure, a time-out period of three minutes is preset within the disclosed system to ensure that a system user has not maintained a capsule in a locked condition when he/she has been pulled away from his/her workstation, focused on alternative projects and/or left the office for the day.

If the time-out feature is activated, a count-down clock 316 appears within capsule and begins a count-down toward zero. In the exemplary embodiment described herein, the count-down covers a period of thirty (30) seconds, although alternative count-down periods may be employed, as will be readily apparent to persons skilled in the art. A system user may deactivate the count-down feature by clicking on count-down clock 316, thereby resetting the count-down feature to a dormant state. However, if after the reset, capsule 282 remains in a locked condition for a period that exceeds the predetermined threshold, the count-down feature will again be activated by the disclosed system and count-down clock 316 will again appear within capsule 282, as described herein.

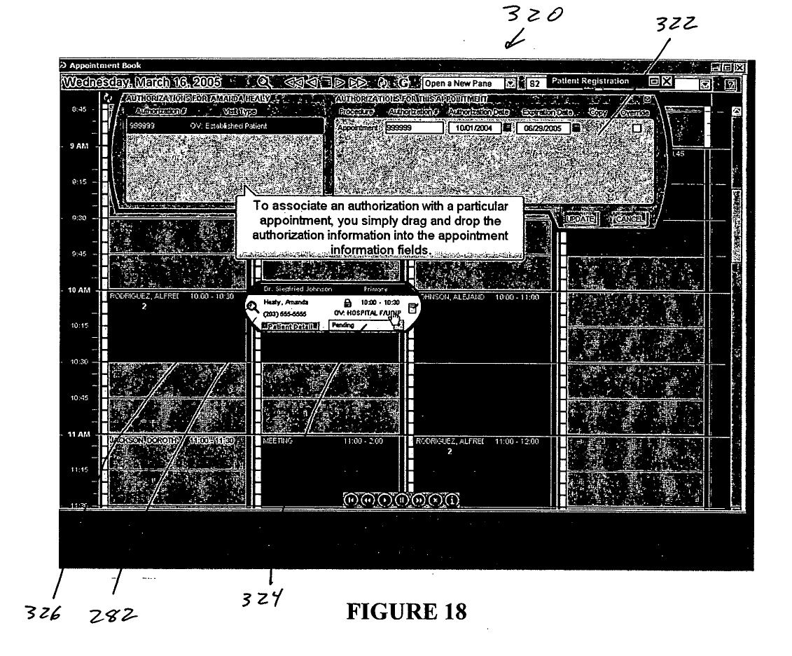

Turning to FIG. 18, a further advantageous feature and functionality associated with the disclosed system is depicted with reference to appointment book screen 320. As depicted in FIG. 18 and as is apparent from a comparison with FIGS. 15-17, the system user has modified the visit type set forth on capsule 282 from “OV: Established Patient” to “OV: Hospital F/U NP”. In making the visit type modification, the system automatically provides the system user with the opportunity to assess the authorization status for treatment of Ms. Healy for the newly entered visit. In that regard, an authorization window 322 appears in FIG. 18 which allows the system user to associate an authorization with the newly entered treatment/condition to be addressed during the scheduled visit. As noted in balloon 324, a system user is able to associate an authorization for a patient with a particular appointment using drag-and-drop functionality to place the relevant authorization information into the appointment information fields, i.e., drag the authorization from the left side of authorization window 322 to the right side of the authorization window. To enter the association of the authorization with the treatment/procedure, the “update” link on the authorization window is selected. The drag-and-drop functionality greatly expedites the authorization process, and facilitates effective and reliable billing/collection procedures.

With further reference to capsule 282, status drop-down box 324 provides the system user with an ability to update and/or modify the status of a patient visit. For example, the appointment may be canceled (for a variety of reasons), bumped, rescheduled or completed. Drop-down box 324 generally provides a series of status choices that are frequently encountered in office operation. Of note, if the status is changed to “appointment kept”, the disclosed system advantageously and automatically checks to determine whether the patient's co-pay has been received in connection with the patient visit. If the co-pay has not been received (or entered into the system as having been received), encounter box 312 (see FIG. 17) appears on the system user's screen, thereby permitting the system user to address the co-pay issue and enter appropriate information concerning the patient visit in a timely manner. Of note, encounter box 312 may be accessed, as needed, by the system user at any time by clicking on the visit type field, as noted above.

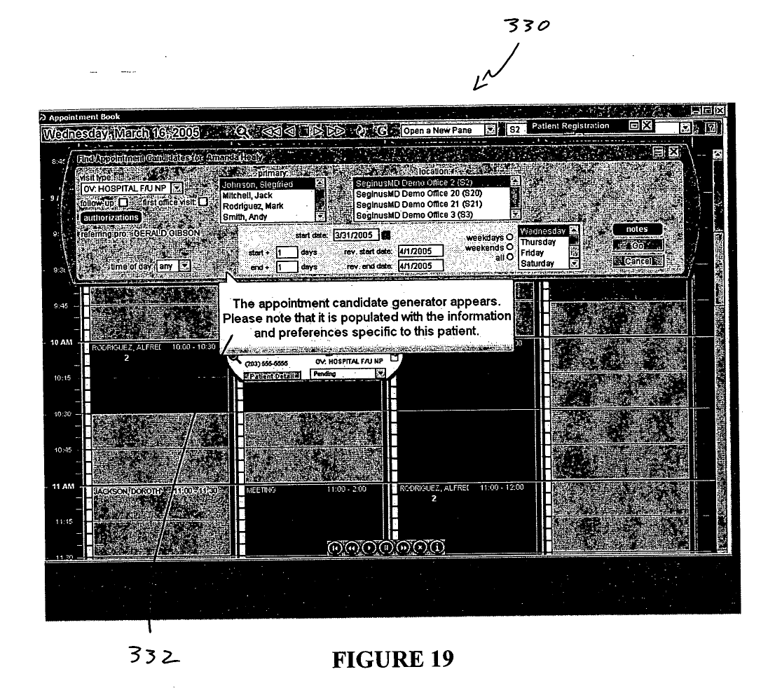

Magnifying glass icon 326 provides access to a search functionality that is advantageously associated with the disclosed system. By clicking on magnifying glass icon 326, the disclosed system opens a “find appointment candidate” screen 330, as shown in FIG. 19. The disclosed functionality advantageously generates a list of appointment candidates or openings. As noted in balloon 332, the find appointment candidate screen 330 is pre-populated with information and preferences that are specific to the patient-of-interest (Amanda Healy), e.g., primary physician and preferred office location. The system is also pre-populated with information based on the specific appointment-of-interest, and defaults to the provider/clinician listed on the appointment, rather than the patient's preferred provider/clinician. The system also defaults to the visit type, day of week and office location associated with the selected appointment. Each of these values may be changed by the system user, as needed.

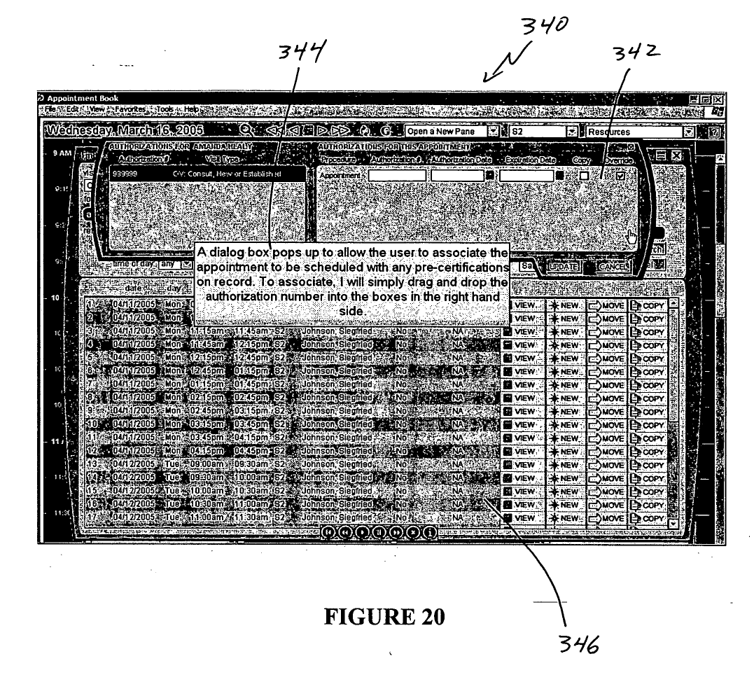

Thus, the system user is able to generate appointment candidates by entering relevant information, e.g., time of day, week date, visit type, etc., and selecting the “go” button. As shown in FIG. 20, the system automatically generates a dialog box 342 and a listing 346 of appointment candidates. As noted in balloon 344, the dialog box 342 permits a user to associate a patient appointment with an appropriate pre-certification on record for the patient. As noted previously, advantageous implementations of the disclosed system permit authorizations to be associated with a patient visit through drag-and-drop functionality. Thus, a pre-certification that appears in the left column of dialog box 342 may be applied to or associated with the appointment being scheduled for the patient by dragging the pre-certification to the column on the right side of dialog box 342, and dropping such certification information onto the appointment, then clicking the “update” button. Of note, the disclosed system automatically associates relevant information related to the pre-certification, e.g., authorization date and expiration date, with the patient's appointment.

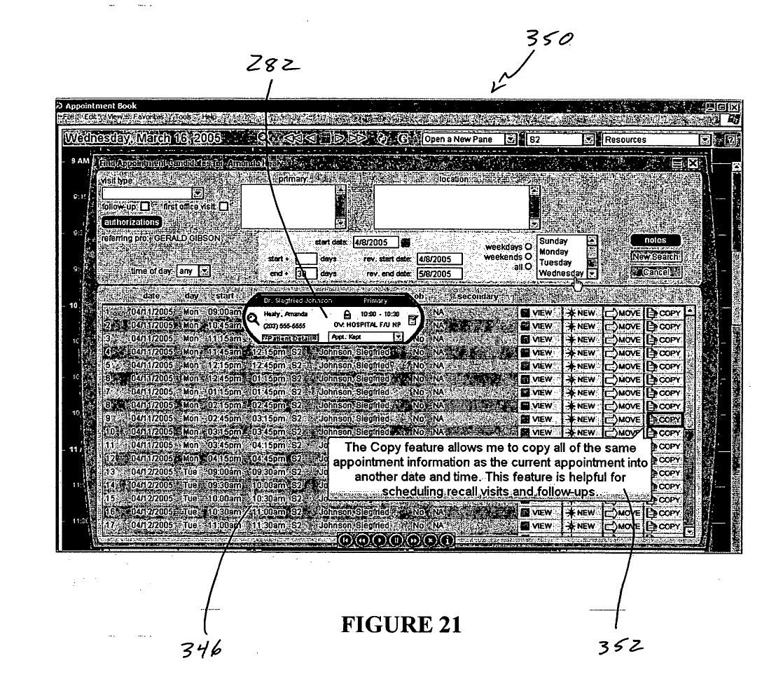

Turning to FIG. 21, a further screen 350 associated with the “find appointment candidates” functionality of the disclosed system is provided. A total of seventeen (17) appointment candidates are visible on screen 350. Using appointment candidate #9 as an illustrative example, the disclosed system has determined that Dr. Siegfried Johnson would be available to see Ms. Healy on Monday, Apr. 11, 2005, in office location S2 at 3:45 p.m. Appointment candidate #9 satisfies the search criteria established by the system user (start date: Apr. 8, 2005; any time of day) and the patient preferences (see FIG. 19), i.e., preferred office location (S2) and primary clinician (Siegfried Johnson). The 30 minute time slot was utilized by the system in generating appointment candidates, including appointment candidate #9, based on the visit type (OV: Consult, new of established), as set forth in dialog box 342 on FIG. 20.

Four navigation options are associated with the appointment candidates, including specifically appointment candidate #9: view, new, move and copy. With initial reference to the “copy” option and as noted in balloon 352, selection of the copy link by a system user allows the system user to copy all information associated with the present patient visit into the appointment being scheduled. Copying is generally accomplished through drag-and-drop functionality, whereby the current visit capsule 282 is dragged over a pop-up box associated with the appointment being scheduled, and dropped. This copy functionality increases the efficiency of system users and avoids potential data entry errors.

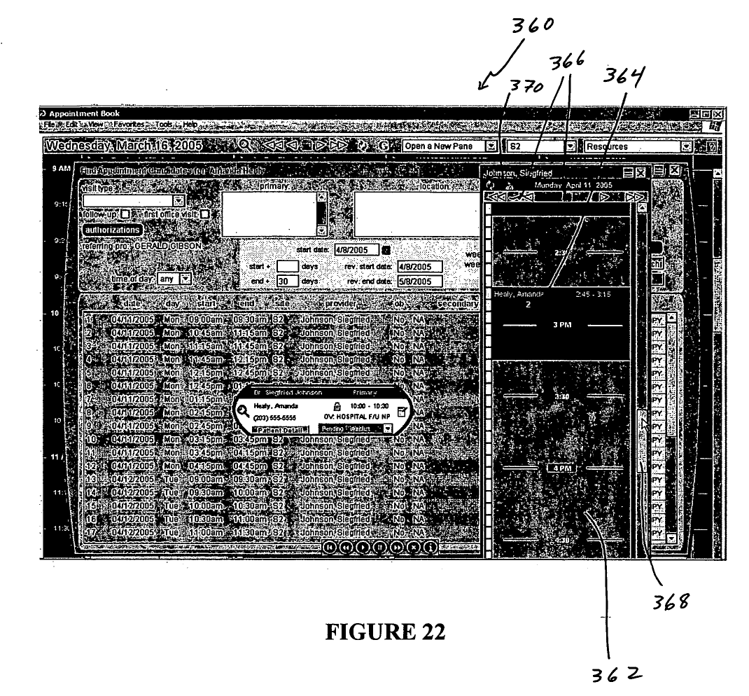

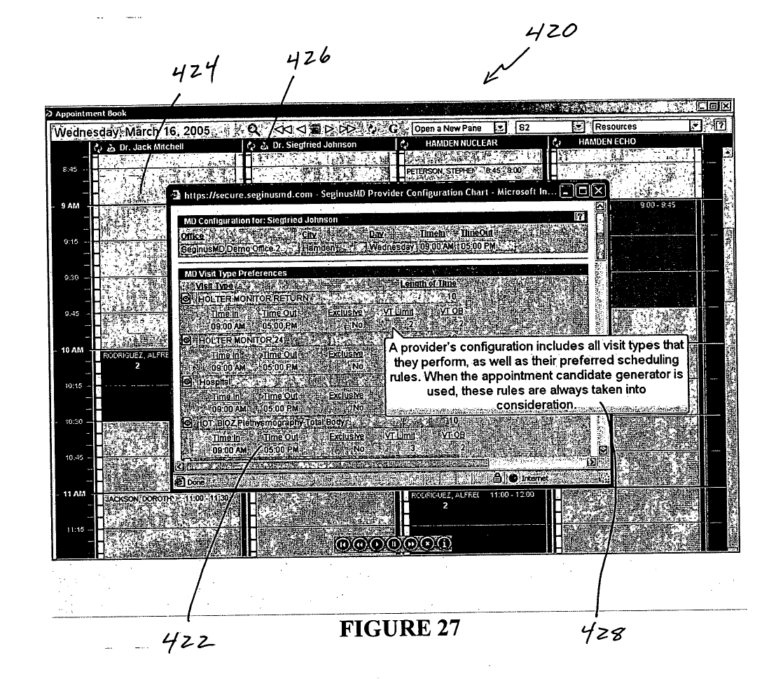

As shown on screen 360 of FIG. 22, a system user is able to view the newly scheduled appointment (or potentially scheduled appointment) on an overlaid calendar pane 362 by selecting the “view” link on screen 350. Overlaid calendar pane 362 is specific to Dr. Johnson's schedule on Apr. 11, 2005. Numeric icon 364 is automatically generated by the disclosed system and alerts the system user that the patient is scheduled for multiple (two) visits on the selected date, i.e., April 11^{th}. Calendar pane 362 includes a variety of navigational links, e.g., date modification links 366 (arrows and calendar icon) and up/down navigation bar 368 that permits the system user to view different time slots on the selected date. In addition, clinician link 370 permits the system user to view a clinician's areas of expertise/service and preferences, as described in greater detail with reference to screen 420 of FIG. 27 below.

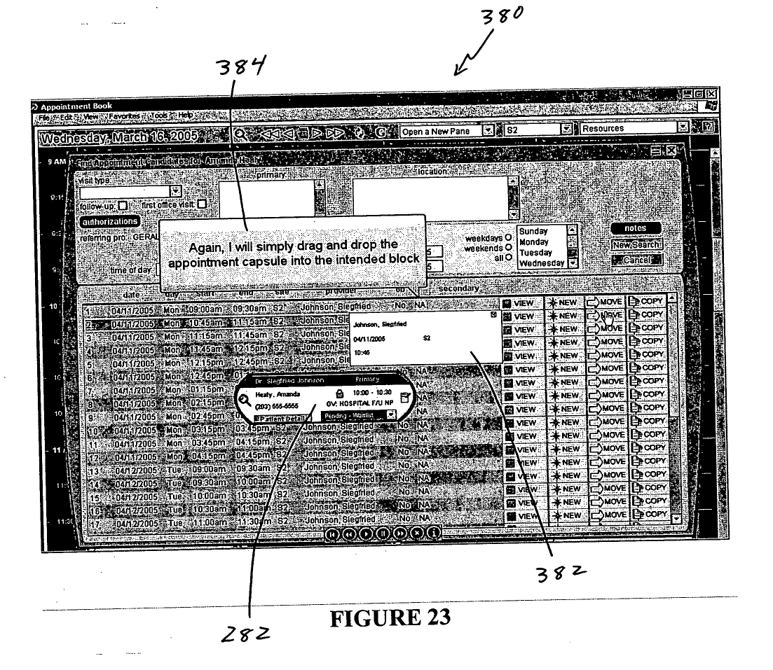

Turning to FIG. 23, operation of the “move” functionality is illustrated on screen 380. As shown on FIG. 23, the system user has selected appointment candidate #2 as a desirable slot for the rescheduling of the appointment reflected in capsule 282. To effect the rescheduling of such appointment, the system user selects the move link associated with appointment candidate #2. In response to selection of the move link, the system automatically generates an appointment block 382 corresponding to appointment candidate #2 (Apr. 11, 2005; 10:45 a.m., Dr. Johnson). As noted in balloon 384, the system user is able to reschedule the appointment reflected in capsule 282 through drag-and-drop functionality, i.e., by dragging capsule 282 over appointment block 382 and dropping the capsule. In response to such system user action, the disclosed system automatically moves the appointment reflected in capsule 282 to the new time slot, i.e., the slot reflected as appointment candidate #2. The view link allows the system user to confirm that the appointment has been rescheduled, as desired, by generating a calendar pane for review by the system user.

With further reference to FIGS. 20-23, the “new” link permits the system user to establish a new appointment, i.e., an appointment that is not directly related to the information captured in capsule 282, based on a potential appointment date. Thus, for example, by selecting the “new” link associated with appointment candidate #9, the system user will be provided with an appointment scheduling box that permits entry of appropriate concerning the new appointment for Ms. Healy.

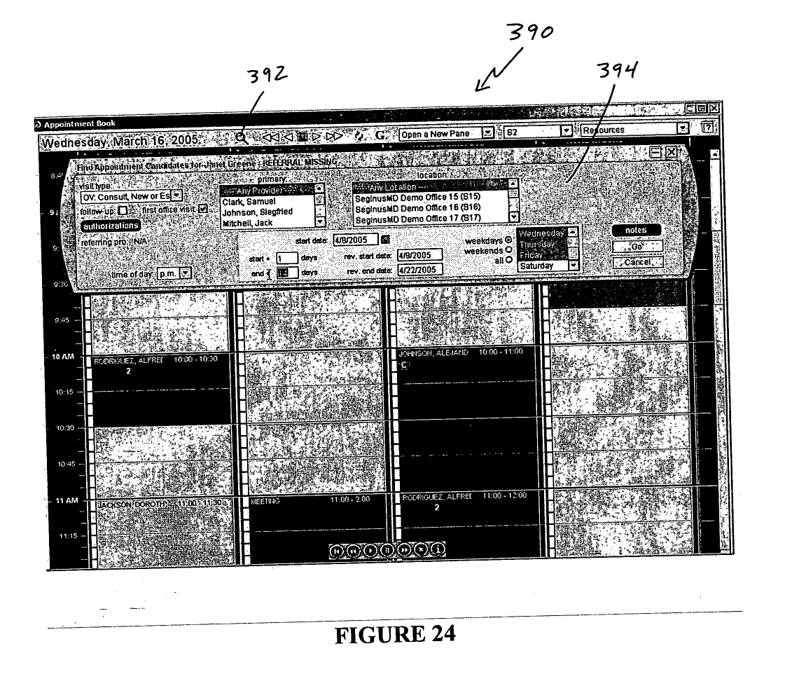

Similarly, a system user can establish a new appointment from the appointment book screen, as illustrated in FIG. 24. For purposes of screen 390, the system user has used the magnifying glass icon 392 to search for the existence of a patient record for a patient/potential patient, namely Janet Greene. Selection of icon 392 provides a search box with various data fields that may be used to search the patient records associated with the office and/or practice. If a patient record is not located in response to such search criteria, the system user is provided with a patient registration screen that permits entry of relevant information. Thereafter, the system generates “find appointment candidates” box 394 for use in identifying appointment candidates for Ms. Greene. Box 394 permits the system user to enter appropriate criteria for use by the system in identifying appointment candidates for Ms. Greene, e.g., visit type (OV: Consult), time of day (p.m.), start date (Apr. 8, 2005) and day of week (weekdays). Other search criteria have been left unspecified, thereby permitting the system to retrieve appointment candidates without limitation as to such data field, e.g., provider/clinician and location.

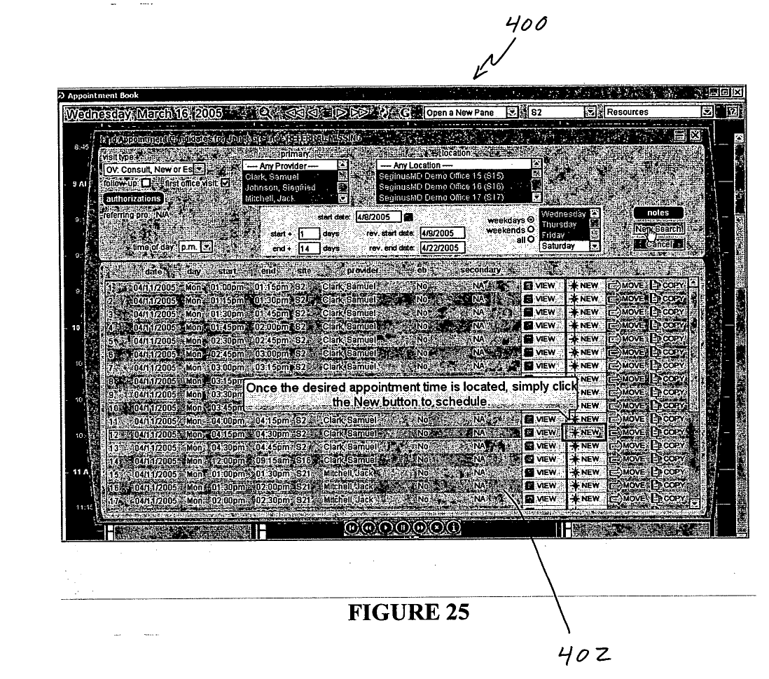

The system user obtains a listing of appointment candidates based on the above-noted search criteria by selecting the “go” button on box 394. As shown in screen 400 of FIG. 25, a listing 402 of appointment candidates are generated by the system in response to the noted search criteria. Based on the manner in which the system user has set about scheduling this appointment for Ms. Greene, there is no existing appointment capsule to utilize in scheduling Ms. Greene's proposed visit (compare FIG. 21). Thus, the system user schedules the proposed appointment using the “new” link associated with an appointment candidate that is satisfactory to the patient, e.g., appointment candidate #12 on April 11^{th} with Dr. Clark.

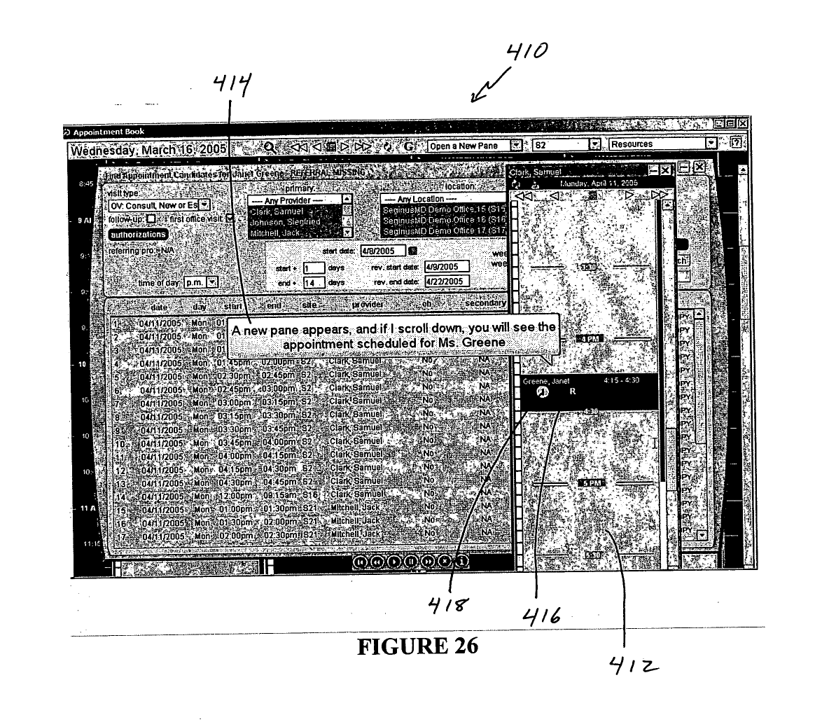

According to exemplary embodiments of the present disclosure, the proposed appointment is fully scheduled by clicking the “new” link associated with a desired appointment candidate, and the scheduled appointment may then be confirmed/checked by clicking the “view” link associated with the appointment candidate. The “view” link also permits a system user to view the schedule for a provider/clinician on the day of the appointment candidate prior to scheduling, thereby permitting the system user to determine whether to fill the opening. Thus, the system user is able to better balance the calendars of providers/clinicians. As noted previously, the view link provides a calendar pane for review by the system user, e.g., Dr. Clark's calendar for April 11^{th} based on appointment candidate #12. As shown in FIG. 26, screen 410 includes calendar pane 412 that includes Ms. Greene's appointment in the desired time slot, as noted in balloon 414. Of note, in addition to icon 418 (the numeral one) reflecting the fact that the scheduled visit is Ms. Greene's first appointment, icon 416 is automatically generated by the system and alerts system users to the fact that Ms. Greene's visit requires a referral that is not yet on file (or entered into Ms. Greene's patient record). This automatically generated icon 416 enhances the efficiency of office/practice operations and minimizes the likelihood that professional services will be rendered that are not reimbursable by the patient's insurance carrier.

With reference to FIG. 27, screen 420 includes a provider/clinician configuration panel 422 overlaid on appointment calendar 424. Panel 422 was accessed through clinician link 424 (which shares functionalities with clinician link 370 referenced above). As shown in exemplary configuration panel 422, the visit types handled by Dr. Johnson are identified with specific limitations and/or criteria associated therewith. The limitations and/or criteria for a specific provider/clinician may be revised and/or updated from time-to-time. As noted in balloon 428, the limitations and/or criteria associated with a provider/clinician are automatically taken into account by the disclosed system in generating appointment candidates for a patient, thereby avoiding the potential for an appointment to be scheduled that conflicts with the clinician's criteria or involves a visit type that the clinician does not handle. As shown on screen 420, clinician links are provided for each provider/clinician, thereby providing a system user with ready access to relevant information as to each provider/clinician.

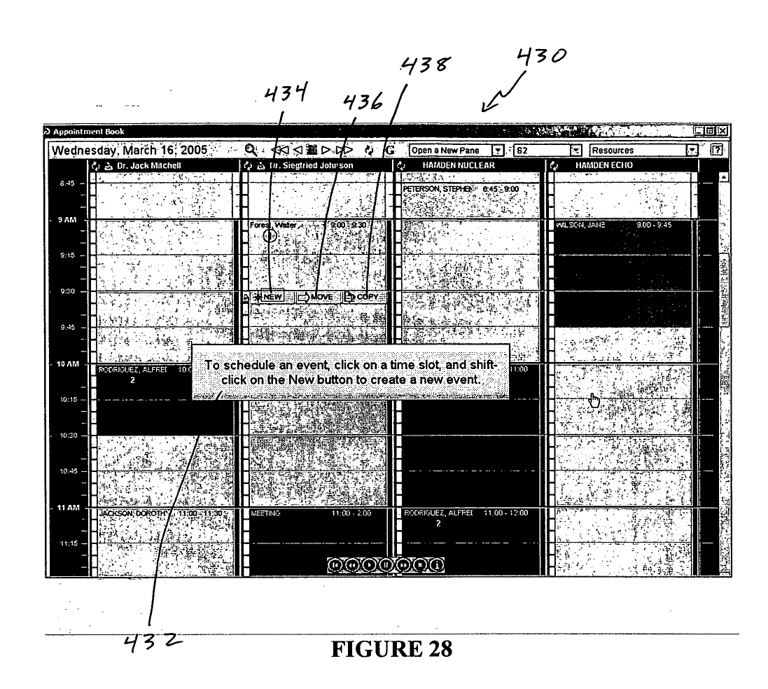

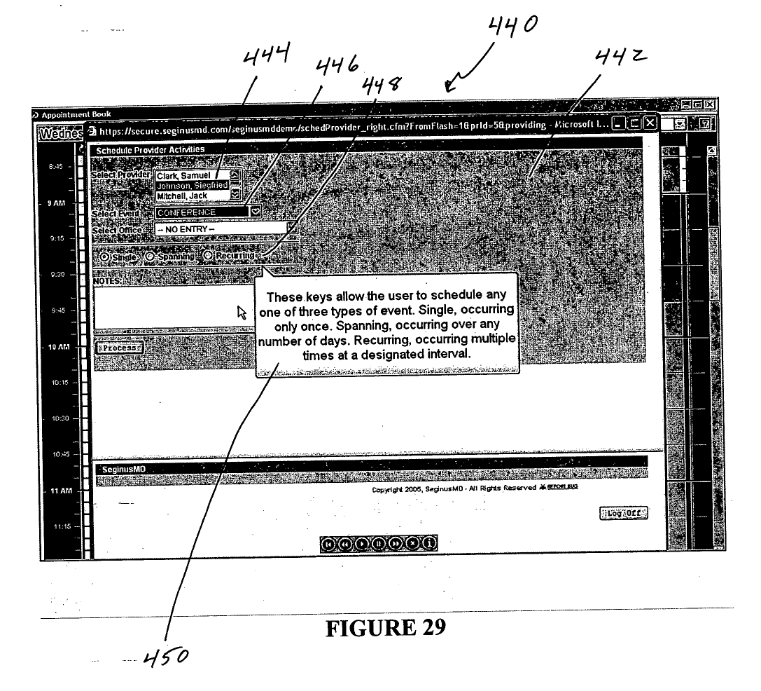

Turning to FIG. 28, appointment book screen 430 illustrates further functionalities associated with event scheduling according to exemplary embodiments of the present disclosure. As noted in balloon 432, an event may be scheduled in a time slot by clicking on the time slot of interest, thereby accessing a series of links: new link 434, move link 436 and copy link 438. When a system user clicks on a time slot, the disclosed system advantageously locks such time slot, thereby permitting a second system user from accessing the time slot and potentially scheduling a conflicting appointment. Selection of new link 434 causes an event scheduling form 442 to be provided, as shown on screen 440 of FIG. 29. Event scheduling form 442 permits the system user to select a provider/clinician in data field 444, an event type in data field 446 (typically from a drop down menu), and the frequency of the event using selection keys 448. As noted in balloon 450, a system user can select from among keys 448 based on whether the event is a one-time scheduling issue, an event that will span several days, and/or an event that will recur at defined frequencies.

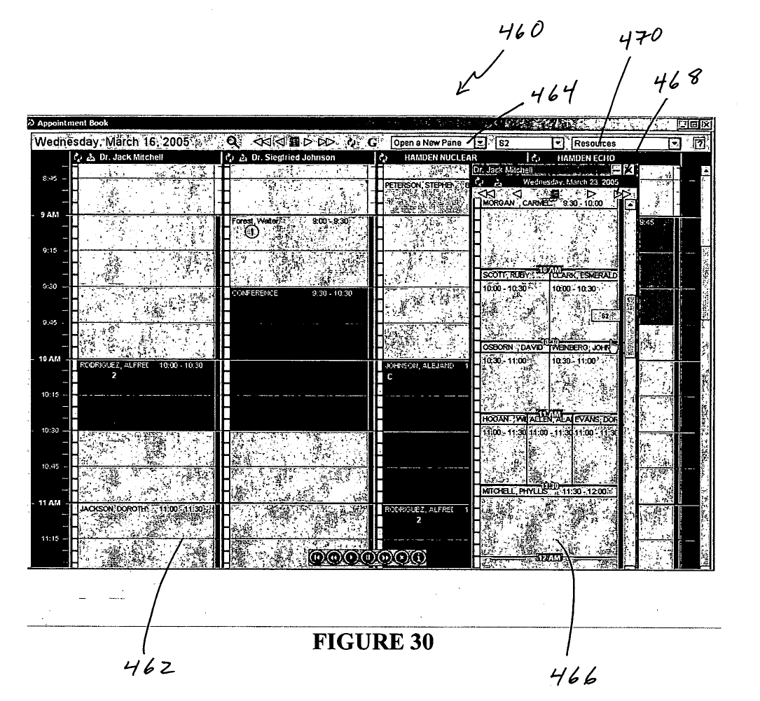

Turning to FIG. 30, an additional advantageous functionality associated with the present disclosure is described with reference to screen 460. Along the upper edge of screen 460 is a link 464 entitled “open a new pane”. Link 464 is associated with a drop-down menu that provides a listing of providers/clinicians associated with the office/practice. By accessing the drop-down menu associated with link 464, a system user can access an additional appointment pane 466. Thus, in the exemplary illustration of FIG. 20, the system user has selected Dr. Jack Mitchell and has navigated (using navigation arrow 468) one week forward on appointment pane 466 to Wednesday, Mar. 23, 2005. Of note, additional pane 466 overlaying appointment screen 462 permits the system user to access additional information without losing attention and/or access to the current day's appointment book, i.e., appointment screen 462 for March 16^{th}.

The ability to access an additional appointment pane 466 is a powerful tool. System users can simultaneously navigate in various chronological directions for various providers/clinicians (at various office locations), so as to gain a full picture of the scheduling options and/or appointment status for the benefit of patients and/or providers/clinicians. The system user has full scheduling functionality from appointment pane 466, but can easily return to the current appointment screen 462 or such other jumping off point as may have existed at the time link 464 was utilized. Of further note, pane 466 may be repositioned on screen 460 through drag-and-drop functionality, thereby permitting the system user to view information that is otherwise blocked by pane 466. Moreover, pane 466 may be minimized by the system user, for future access, using conventional minimization techniques.

With further reference to FIG. 30, resources link 270 permits a system user to review the status of various resources, e.g., equipment, specialized facilities and the like, from a drop-down menu. As with appointment pane 466 described above, the disclosed system permits a resource-related pane to be overlaid on appointment screen 462, whether alone or in combination with clinician-related panes 466. The ability to review the status and availability of a resource through an overlying pane further enhances the power and flexibility of the office and/or practice management applications of the present disclosure.

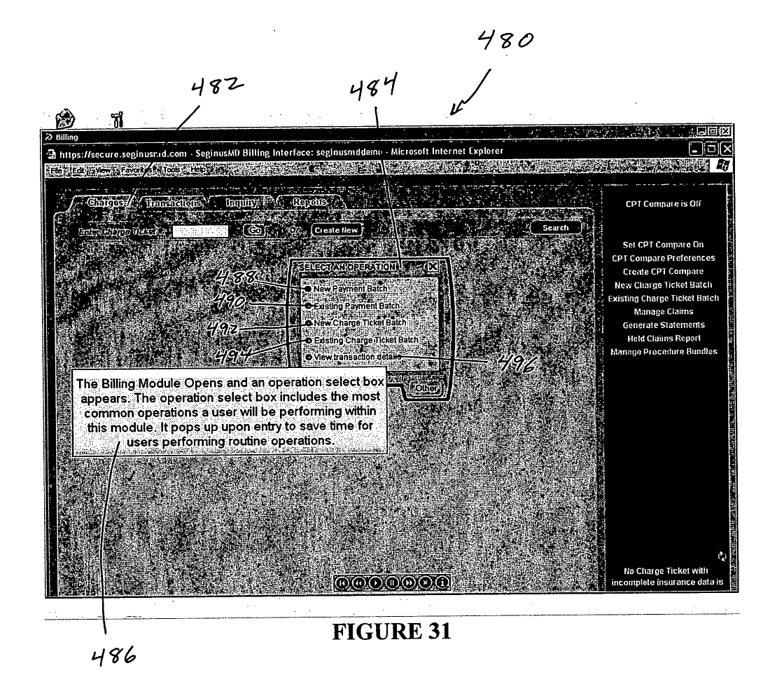

Turning to advantageous functionalities associated with the disclosed systems and methods, it is initially noted with reference to FIG. 3 that multiple links to patient billing functions may be provided according to the present disclosure: patient billing link 150 and “$” link 166. Each of the noted billing-related links 150, 166 provides a system user with access to the billing functions associated with exemplary embodiments of the present disclosure. Thus, with reference to FIG. 31, billing screen 480 is accessed through either link 150 or link 166. The billing module associated with the present disclosure includes a plurality of billing functions, as reflected in the operational links associated with charge tab 482 and located in operation select box 484 on billing screen 480. In particular and as noted in balloon 486, charge functionalities associated with the present enclosure include: new payment batch link 488, existing payment batch link 490, new charge ticket batch 492, existing charge ticket batch 494 and view transactions details 496.

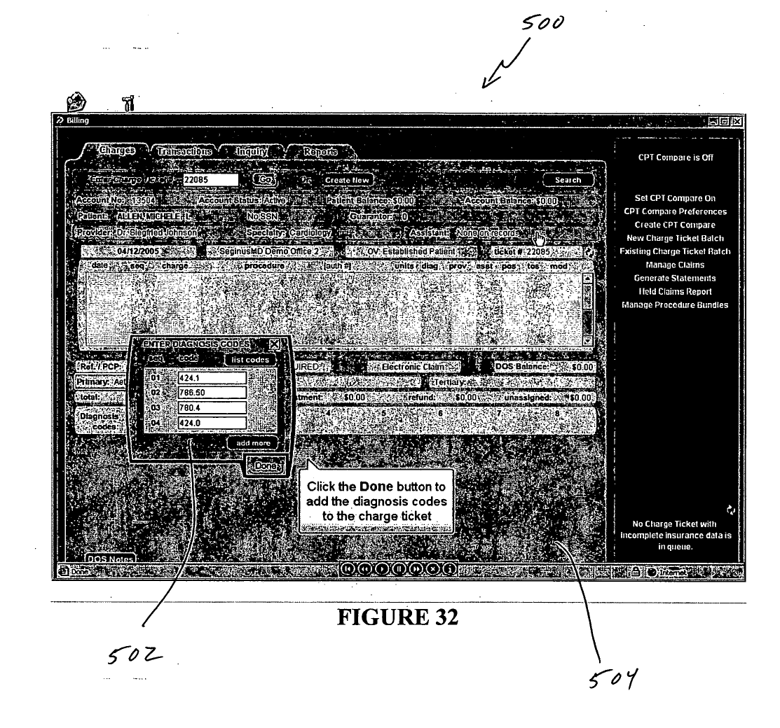

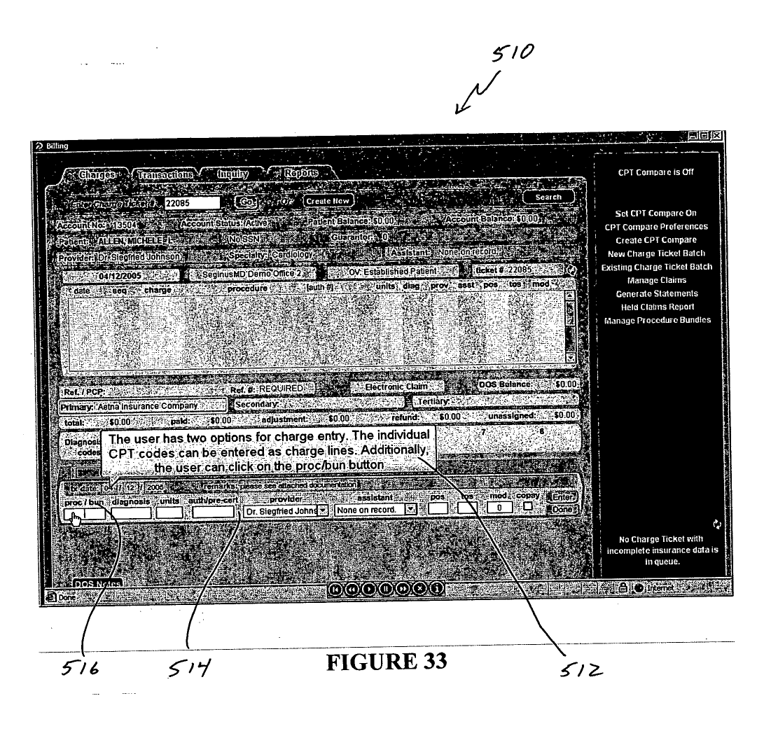

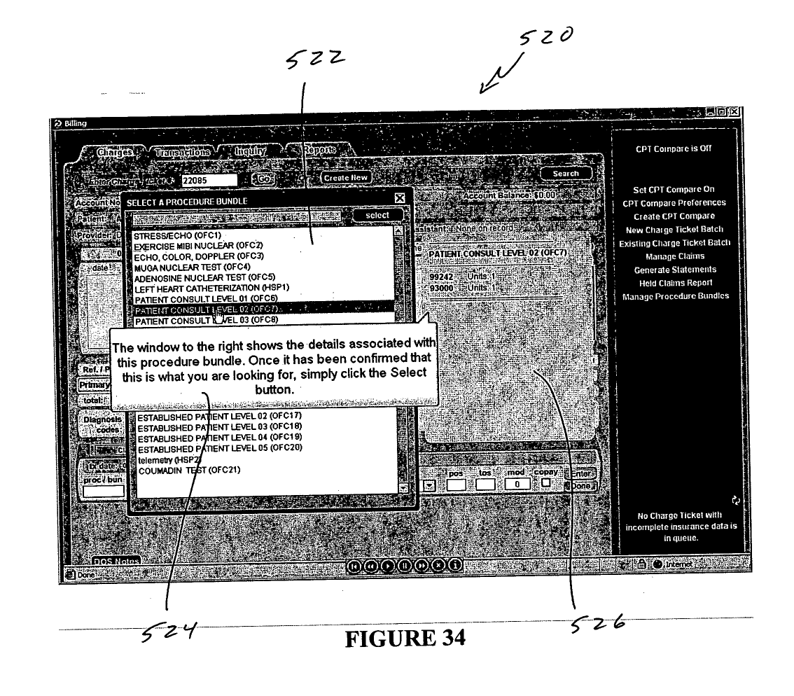

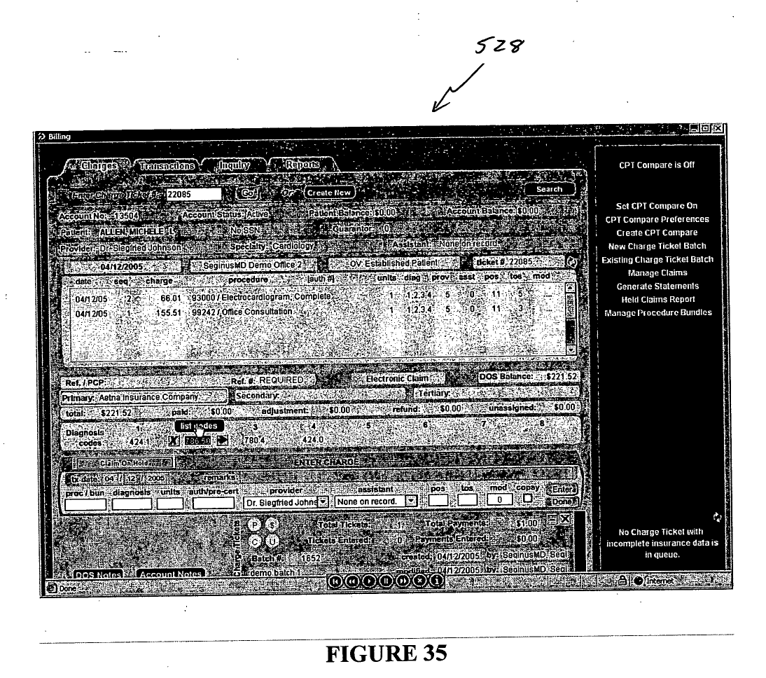

With reference to FIG. 32, an exemplary charge ticket screen 500 is depicted. A diagnosis code box 502 for entry of relevant diagnosis codes is overlaid on the underlying charge ticket record 504. A drop-down menu of diagnosis codes (not pictured) may be accessed from diagnosis code box 504 (“list codes” link) to facilitate identification of entry of appropriate diagnosis codes. Turning to the charge ticket screen 510 of FIG. 33 and as noted in balloon 512, the disclosed system offers system users with two options for charge entry. Individual CPT codes may entered as charge lines on charge code box 514 and the system user can access bundled procedure codes by clicking the “proc/bun” link 516. Thus, as shown in FIG. 34, a pre-populated listing of procedure bundles 522 may be accessed from link 516. The bundles may be modified based on the nature of the office/practice utilizing the disclosed system. By selecting a procedure bundle, the system user can view the individual codes associated with such bundle, as shown in exemplary procedure bundle 526. As noted in balloon 524, once the system user has confirmed that the procedure bundle is the one-of-interest, it may be entered into the charge ticket by clicking on the select button. With reference to FIG. 35, charge ticket screen 528 shows the procedure codes associated with the selected procedure bundle being entered on the charge ticket. Errors in charge codes may be addressed through an edit functionality associated with the disclosed system.

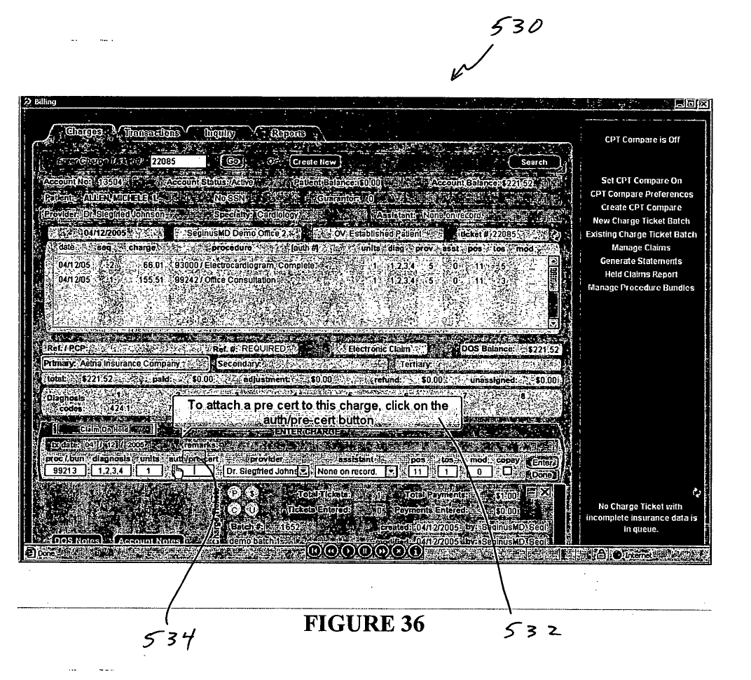

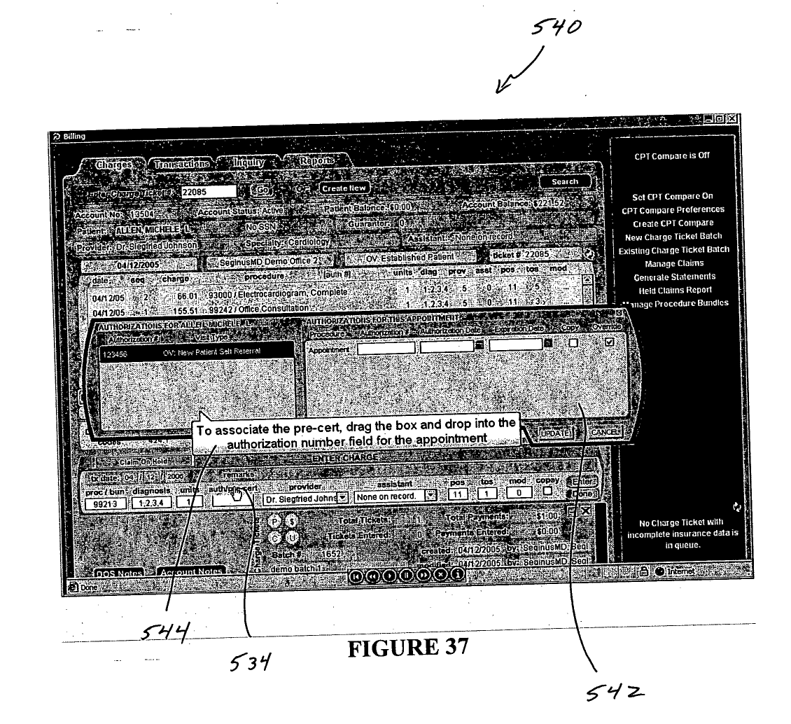

The billing functionalities associated with the disclosed system also advantageously permit an authorization/pre-certification to be attached to a charge ticket. With reference to screen 530 of FIG. 36, the system user can attach an authorization/pre-certification to the charge ticket by clicking the “auth/pre-cert” link 534, as noted in balloon 532. Thus, as shown in FIG. 37, an authorization box 542 is accessed using the “auth/pre-cert” link 534, which permits the system user to easily associate an existing pre-certification for the patient (Michele Allen) with the appointment that is being charged. As noted in balloon 542, the system user can effect the desired association through drag-and-drop functionality, by dragging the authorization at the left of authorization box 542 onto the authorization field on the right side of authorization box 542. By clicking the “update” link on authorization box 542, the authorization/pre-certification will be added to the charge ticket.

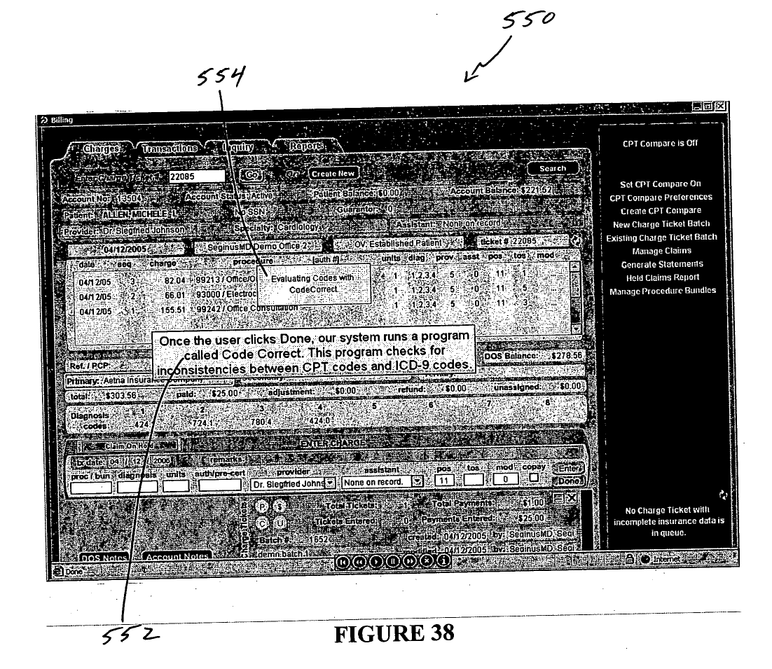

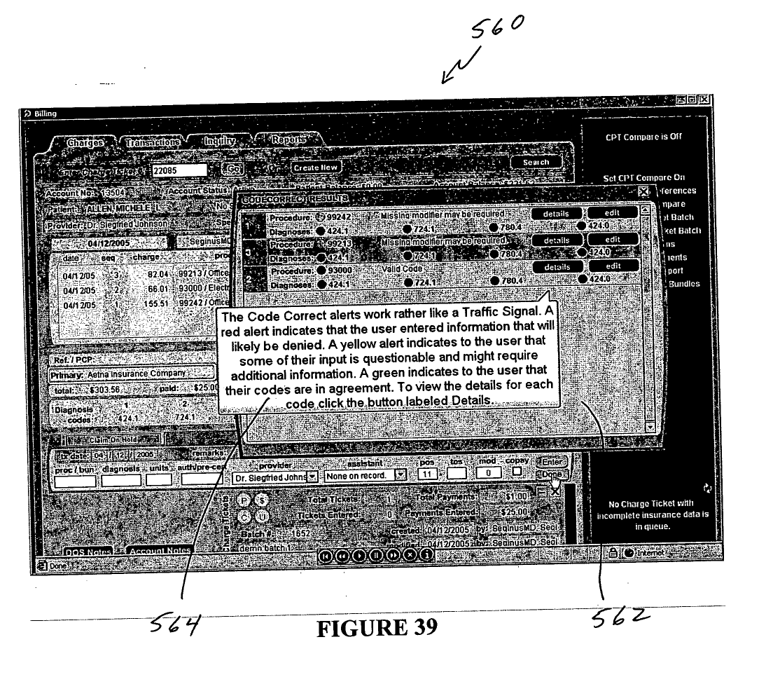

With reference to FIG. 38, additional advantageous functionality associated with the billing system of the present disclosure is disclosed. More particularly, once a system user completes his/her entry of billing codes in connection with a charge ticket, the disclosed system advantageously runs a third party program called “Code Correct” that identifies any inconsistencies between CPT and ICD codes. As noted in balloon 552, the Code Correct program is initiated when the system user selects the “Done” button in connection with billing code entry. A status box 554 alerts the system user that the system is “evaluating codes with code correct.” The Code Correct program returns raw data, from which the disclosed system generates a CodeCorrect Results screen 562, as shown on screen 560 of FIG. 39. According to exemplary embodiments of the present disclosure, the disclosed system follows CodeCorrect's color-coding conventions in its display. All of the functionalities associated with the CodeCorrect display, e.g., details, edit, etc., are executed by the disclosed system. As noted in balloon 564, the Code Correct program identifies potential issues with a three color alert system: a “red alert” indicates that the charge-related information is likely to be denied; a “yellow alert” indicates that some of the inputted information is questionable and may require additional supporting information; and a “green alert” indicates that the CPT and ICD codes are in agreement. Details may be viewed by clicking on a “details” link associated with a procedure code of interest.

According to the present disclosure, each claim is assigned a unique identification number for future reference/tracking purposes. The disclosed system automatically generates the unique identification by combining patient identification number with the ticket number associated with the claim, thereby generating an identification number that is easily understood by system users and that facilitates subsequent inquiries/tracking. The unique identification for each claim provides an efficient and effective tracking and management tool for system users, as will be readily apparent to persons skilled in the art.

The disclosed system permits broad-based editing and data review from the charge ticket screens shown in FIGS. 32-39. Thus, a system user can access/edit information contained in the various data fields, e.g., provider/clinician, primary insurance provider, etc., by clicking on the relevant data field. Once changes/edits are made to such data fields, the revised/modified information will be associated with the charge ticket. When the system user is satisfied with the data entry associated with a charge ticket, he/she associates the charge ticket may be included in a claims batch by clicking the “manage claims” button included in the navigation links at the right of the charge ticket screen.

The ticket is released to the claims submission process in one of two ways. According to method 1, when the user clicks “done”, if CodeCorrect returns all “green”, then the ticket is immediately released to claims. However, if CodeCorrect returns green and yellow, the system user can elect to release the ticket or hold it for further review. If CodeCorrect returns any “red” alerts, then the ticket is withheld from the claims submission process until the system user corrects the inconsistency or manually releases the ticket using method 2 (described below). According to method 2, the system user can manually release the ticket to the claims process by clicking the button labeled “Claim on Hold”. When he/she does so, the button label changes to “Claim Released”, just as it does when the ticket is automatically released after the code review.

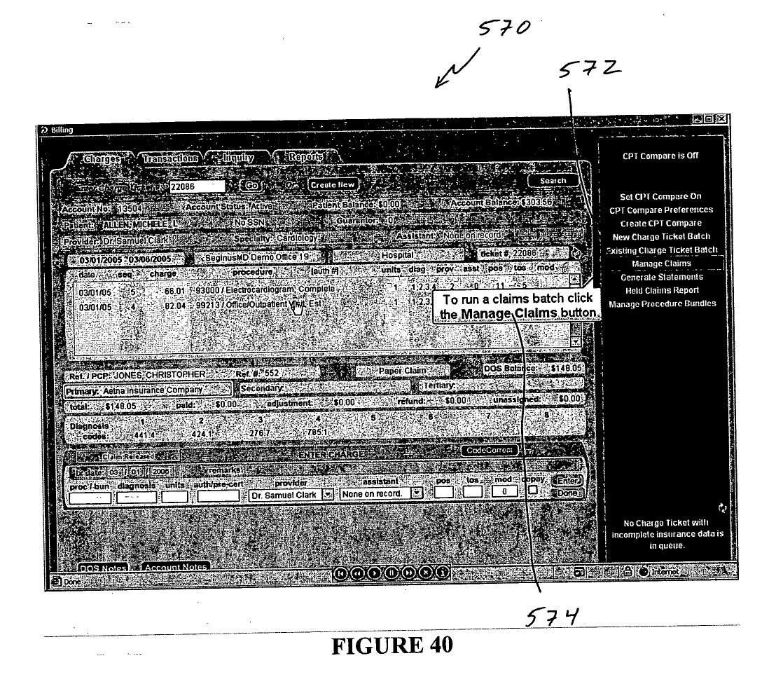

Thus, with reference to FIG. 40, charge ticket screen is complete and the system user can elect to run a claims batch by clicking “manage claims” button 572, as described in balloon 574. The disclosed system permits the system user to elect from among a series of billing options, e.g., electronic submission, paper submission, etc. In this way, the charge ticket may be submitted for processing and payment on behalf of the patient. Of note, when a system user generates a Claims Batch, the disclosed system automatically includes every charge ticket that is ready to be submitted for the type of batch selected. For example, if the system user selects “Primary (electronic)”, then the disclosed system automatically includes all tickets that have been released to the claims submission process but have not yet been submitted, and that are not marked as “Paper Only” by a system user.

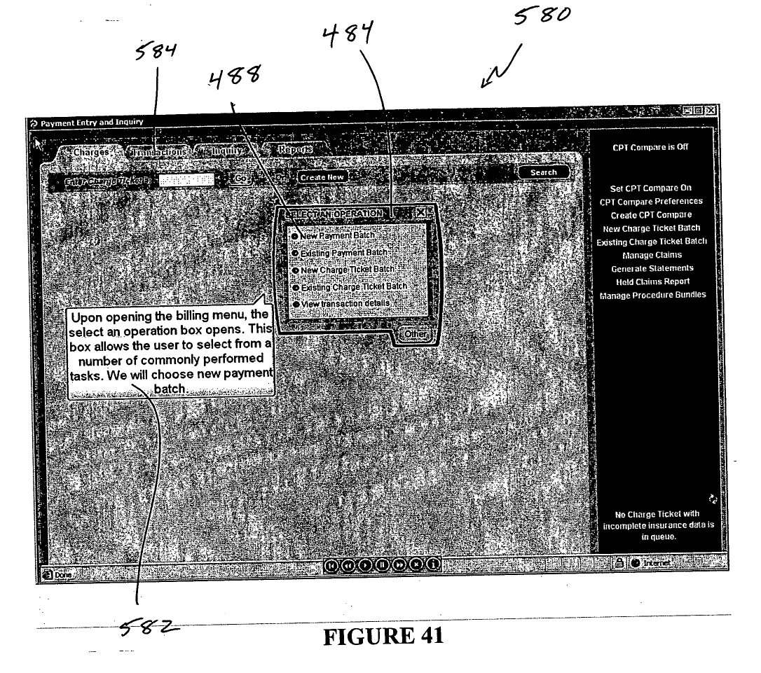

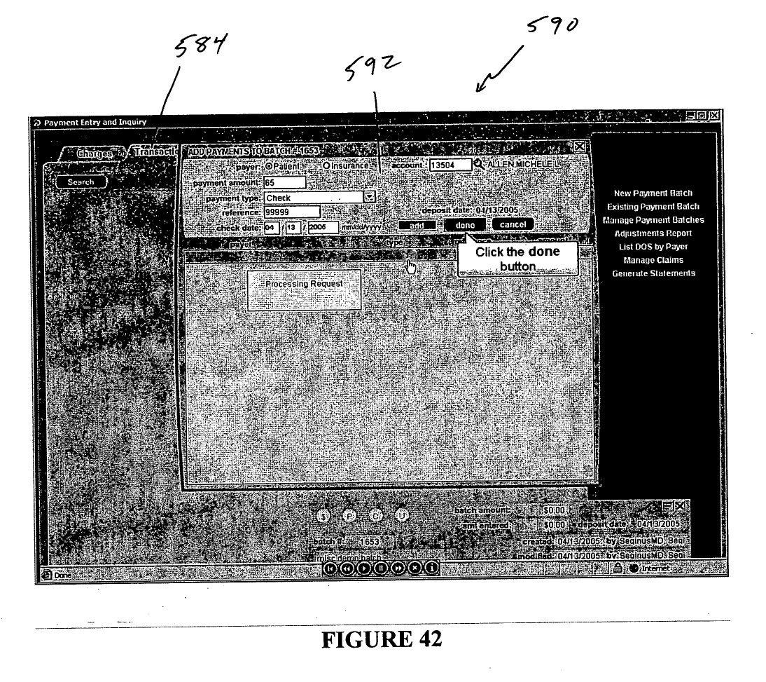

Turning to additional billing and collections related functionalities associated with the disclosed system, reference is made to screen 580 in FIG. 41 (which largely corresponds to screen 480 in FIG. 31), wherein a system user is permitted to select alternative functionalities from the operation select box 484. As noted in balloon 582, the system user can choose the new payment batch link 488 to process a new payment batch. According to the present disclosure, payment batches are associated with the transactions tab 584. As shown on screen 590 of FIG. 42, a system user can enter relevant information concerning a payment that is received by the office/practice on batch payment box 592. On exemplary screen 590, the payment data that has been entered by the system user reflects a payment from the patient in the amount of $65.00 with respect to account #13504. As will be readily apparent to persons skilled in the art, the disclosed system permits various payment sources (e.g., insurance providers) to be captured in batch payment box 592. Once all relevant information has been entered, the “done” button is selected to process the payment as part of the selected batch (batch #1653).

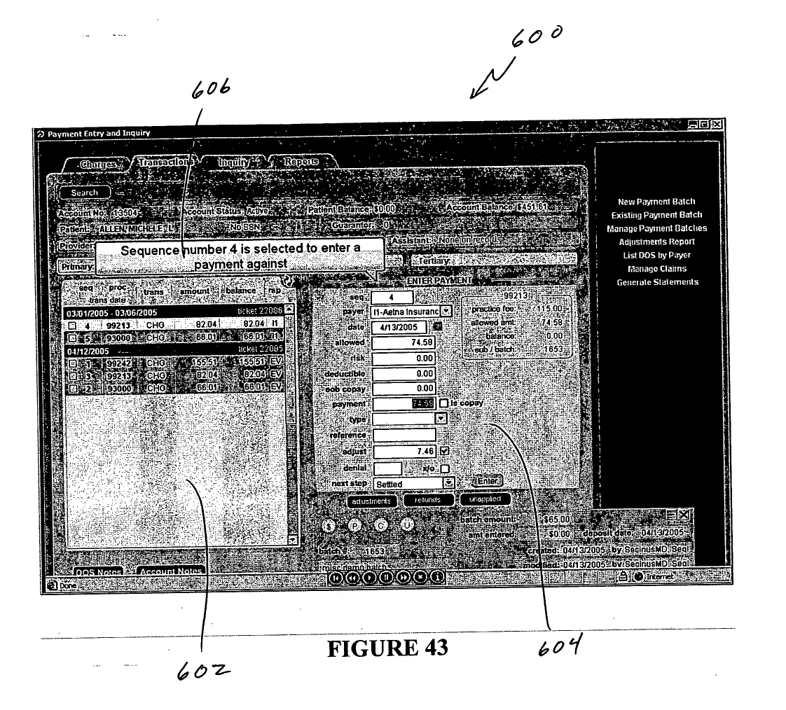

As shown by screen 600 on FIG. 43, the system user is permitted to associate the batch amount ($65.00) with the appropriate transaction sequence. Of note, the disclosed system automatically includes a listing of charges associated with the patient-of-interest (Michele Allen), each of which is assigned a sequence number according to the present disclosure. The sequence number is unique for the patient. For example, each patient can have only one charge with sequence=1. This makes for easier reference, especially in situations where the same procedure (CPT code) is used on more than one visit. With further reference to FIG. 43, the various charges associated with Ms. Allen are included in a listing of charges (list 602) at the left of screen 600.

In the illustrated example, the system user has elected to associate the payment with charge #4 in payment entry box 604, as noted in balloon 606. The disclosed system advantageously populates certain fields associated with the payment in payment entry box 604, including the allowable fee ($74.58) and the designated payer (I1-Aetna Insurance). The disclosed system supports various editing/reversal functionalities, thereby permitting a system user to address errors/inconsistencies in data entries.

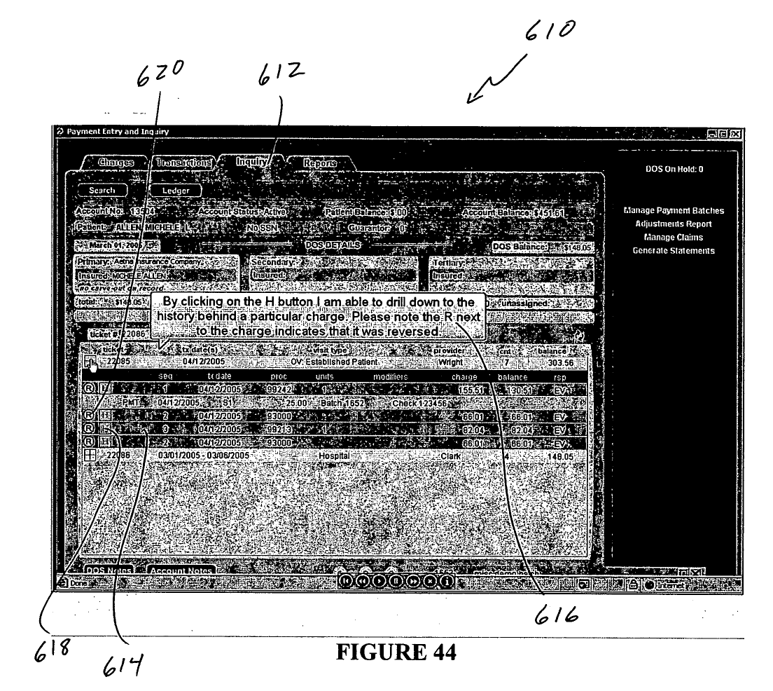

Turning to FIG. 44, functionalities associated with inquiry tab 612 are shown with respect to screen 610 thereof. The disclosed system permits a system user to pursue an inquiry with respect to a patient from a patient-specific record 614 that displays tickets associated with the patient and relevant information associated with each such ticket. As noted in balloon 616, the “H” links 618 associated with each individual billing record allows a system user to access the history associated with a particular charge. In addition, the “R” icon 620 adjacent individual billing records reflects the fact that a billing entry was reversed by a system user.

The disclosed system also supports various ancillary billing-related functions, including the generation of billing statements and various reporting functionalities. Thus, the disclosed system provides a fully integrated and highly advantageous system for office and/or practice management that addresses all aspects of patient/client registration, appointment scheduling and billing/collections. Implementation of the disclosed systems and methods generally involves shared access to a central database that contains data relevant to the office and/or practice management of a user, including patient-specific information, provider/clinician-specific information, and pre-populated data (e.g., billing codes, procedure bundles, and the like).

The disclosed system operates through software that is adapted to access the central database so as to provide the advantageous registration, scheduling and/or billing functionalities described herein. The software may function within an application service provider (ASP) environment, or may be installed on individual servers/processors at individual locations. In a further exemplary implementation of the present disclosure, the software may reside on a central server at each location office/practice location, with individual users at such office/practice location accessing such software over a network established at such office/practice location.

As noted above, advantageous implementations of the disclosed system utilize software that is particularly adapted to operate within and leverage functionalities associated with Macromedia Flash software, e.g., Macromedia Flash Mx 2004 and Macromedia Flash Communication Server MX. The underlying design, operation and functionalities associated with Macromedia Flash applications are known in the art and are described in documentation that is available from Macromedia, Inc. (www.macromedia.com). Utilizing functionalities associated with Macromedia Flash applications, the disclosed system advantageously manages “state” by maintaining connection with multiple users, thereby providing “real time” data updates from the server to all participating users. Indeed, based on functionalities associated with Macromedia Flash applications, the disclosed system/method maintains a connection with all users so as to continually push data from the server, so that distributed users are working with up-to-date information and are not interfering and/or impeding their respective actions and operations. Exemplary embodiments of the present disclosure also utilize and/or leverage functionalities associated with the ASBroadcaster utility embodied in Macromedia Flash, e.g., through broadcastMessage commands that enable an object to send a message that will be captured by any objects listening to it.

As noted herein, the disclosed system and method provide numerous advantages as compared to prior art office and/or practice management systems. While the advantageous features and functionalities associated with the disclosed system/method extend to and encompass various aspects of office and/or practice management, particular advantages associated with the disclosed system and method include:
Enhanced patient/client/customer registration functionalities that facilitate efficient and reliable intake and maintenance of patient/client/customer relationships, including a patient preference functionality that facilitates future appointment scheduling, and a “patient flag” functionality that allows and/or supports extensibility (e.g., linking to an associated document, record or other electronically accessible resource), and a
Enhanced appointment scheduling functionalities that facilitate efficient and reliable identification of service provider availability (together with any required supporting equipment and/or personnel), including an “appointment candidate generator” functionality, a “floating” or “overlaid” provider pane functionality, an “appointment capsule” functionality that facilitates appointment scheduling/rescheduling, a “time block freeze” functionality that allows multiple users to interact with records in the central database without creating inconsistencies and/or anomalies, a “clear day” functionality that facilitates global changes to a service provider's calendar for a given day (or series of days), and a design that supports “drag-and-drop” of files/data across multiple data files/records (e.g., drag-and-drop of .swf files associated with Macromedia Flash).

Enhanced billing functionalities that facilitate efficient and reliable generation of billing records (e.g., claims and/or statements) and reconciliation of payments received with respect to such billing records, including functionalities that ensure/verify pre-validation of payer data, an advantageous billing claim identification methodology, a “countdown” functionality adapted to track and update the status of an individual's visits relative to a predetermined number of authorized visits, and location-specific CPT/Medicare fee schedules that are automatically matched to a patient's billing records.

Although the present disclosure has been described with reference to exemplary implementations thereof and, indeed, with reference to exemplary screen views associated with an illustrative medical office implementation, it is to be understood that the present disclosure is not limited to such exemplary implementations. Rather, the illustrative embodiment and screen shots disclosed herein are merely exemplary of potential implementations and applications of the disclosed systems and methods. Indeed, the present disclosure is susceptible to various modifications, variations and/or enhancements without departing from the spirit or scope of the disclosed systems and methods. Accordingly, the present disclosure expressly encompasses such modifications, variations and/or enhancements to the exemplary embodiments described herein.

1. A computer-based system for supporting office management operations, comprising:
a. a computer network that includes at least one server and a central database; said server communicating with said central database and including a processing unit that is adapted to run computer software that includes programming that is adapted to perform the following functions:
i. dynamically generate and display an appointment calendar that includes appointment schedules for a first entity; and
ii. dynamically generate and display an additional overlaid appointment pane that includes an appointment schedule for a selected entity.

2. A computer-based system according to claim 1, wherein said first entity is selected from the group consisting of clinicians, service providers, resources, facilities and combinations thereof.

3. A computer-based system according to claim 1, wherein said selected entity is selected from the group consisting of a clinician, a service provider, a resource and a facility.

4. A computer-based system according to claim 1, wherein said first entity and said selected entity are the same entity.

5. A computer-based system according to claim 1, wherein said computer software is further programmed to permit navigation within both said appointment calendar and said additional overlaid appointment pane.

6. A computer-based system according to claim 1, wherein said computer software is further programmed to support patient registration functionality.

7. A computer-based system according to claim 6, wherein said patient registration functionality includes input of patient preferences.

8. A computer-based system according to claim 1, wherein said computer software is further programmed to access patient preferences input to said central database, said patient preferences being selected from the group consisting of preferred clinician, preferred service provider, preferred office location, preferred day of week for appointment, preferred time of day for appointment, and combinations thereof.

9. A computer-based system according to claim 6, wherein said patient registration functionality includes generation of a patient flag.

10. A computer-based system according to claim 9, wherein said patient flag is adapted to link to an electronically accessible resource.

11. A computer-based system for supporting office management operations, comprising:
a. a computer network that includes at least one server and a central database; said server communicating with said central database and including a processing unit that is adapted to run computer software that includes programming that is adapted to perform the following functions:
i. dynamically generate and display a list of appointment candidates based on appointment criteria provided by a system user; and
ii. schedule an appointment through selection of an appointment candidate from said list of appointment candidates.

12. A computer-based system according to claim 11, wherein said computer software is further programmed to permit dynamic viewing of an appointment calendar associated with an appointment candidate included on said list of appointment candidates.

13. A computer-based system according to claim 11, wherein said computer software is further programmed to generate said list of appointment candidates based on patient-generated criteria.

14. A computer-based system according to claim 11, wherein said computer software is further programmed to associate patient-related information with an appointment candidate selected from said list of appointment candidates.

15. A computer-based system according to claim 14, wherein said patient-related information is associated with an appointment candidate through drag-and drop functionality.

16. A computer-based system according to claim 14, wherein said patient-related information includes information concerning authorization for treatment associated with the patient.

17. A computer-based system according to claim 16, wherein said computer software is further programmed to automatically track the remaining number of authorized treatments associated with a patient.

18. A computer-based system for supporting office management operations, comprising:
a. a computer network that includes at least one server and a central database; said server communicating with said central database and including a processing unit that is adapted to run computer software that includes programming that is adapted to perform the following functions:
i. dynamically generate and display an appointment capsule associated with a patient appointment; and
ii. placing said appointment capsule in a locked condition when a system user accesses data associated with said appointment capsule, thereby preventing a second system user from accessing said appointment capsule while in said locked condition.

19. A computer-based system according to claim 18, wherein said computer software is further programmed to automatically initiate a count-down feature when said appointment capsule has been in said locked condition for a predetermined period.

20. A computer-based system according to claim 19, wherein said count-down feature may be reset through a system user action within the count-down period.

21. A computer-based system according to claim 19, wherein said appointment capsule automatically assumes a non-locked condition at the expiration of a count-down period associated with said count-down feature.

22. A computer-based system for supporting office management operations, comprising:
a. a computer network that includes at least one server and a central database; said server communicating with said central database and including a processing unit that is adapted to run computer software that includes programming that is adapted to perform the following functions:
i. dynamically generate and display an appointment calendar that includes at least one appointment time slot; and
ii. placing said at least one appointment time slot in a locked condition when a system user accesses said at least one appointment time slot, thereby preventing a second system user from accessing said at least one appointment time slot while in said locked condition.
